(19) United States
(12) Patent Application Publication
(10) Pub. No.: US 2014/0210666 A1
(43) Pub. Date: Jul. 31, 2014

(54) APPARATUS, SYSTEM AND METHOD OF WIRELESS COMMUNICATION VIA AN ANTENNA ARRAY

(71) Applicants: Alexander Maltsev, Nizhny Novgorod (RU); Richard B. Nicholls, Banks, OR (US); Ali S. Sadri, San Diego, CA (US); Andrey Pudeyev, Nizhny Novgorod (RU); Vadim Sergeyev, Nizhny Novgorod (RU); Alexei Davydov, Nizhny Novgorod (RU)

(72) Inventors: Alexander Maltsev, Nizhny Novgorod (RU); Richard B. Nicholls, Banks, OR (US); Ali S. Sadri, San Diego, CA (US); Andrey Pudeyev, Nizhny Novgorod (RU); Vadim Sergeyev, Nizhny Novgorod (RU); Alexei Davydov, Nizhny Novgorod (RU)

(21) Appl. No.: 13/869,995

(22) Filed: Apr. 25, 2013

Related U.S. Application Data
(60) Provisional application No. 61/757,082, filed on Jan. 25, 2013.

(51) Int. Cl. H01Q 3/24; H01Q 21/29

(52) U.S. Cl. CPC H01Q 3/24; H01Q 21/29
USPC 342/368; 343/893

(57) ABSTRACT

Some demonstrative embodiments include apparatuses, systems and/or methods of wireless communication via an antenna array. For example, an apparatus may include an antenna array including a plurality of antenna modules arranged along a first axis, an antenna module of the antenna modules including an antenna sub-array coupled to a Radio-Frequency (RF) chain, the antenna sub-array including a plurality of antenna elements arranged along a second axis, the second axis is perpendicular to the first axis, and the RF chain is to process RF signals communicated via the plurality of antenna elements.

### CROSS REFERENCE

This application claims the benefit of and priority from U.S. Provisional Patent Application No. 61/757,082 entitled “Multi-User MIMO Technique in Millimeter-Wave Communication Systems with Large-Aperture Modular Antenna Arrays”, filed Jan. 25, 2013, the entire disclosure of which is incorporated herein by reference.

### TECHNICAL FIELD

Embodiments described herein generally relate to wireless communication via an antenna array.

### BACKGROUND

Some wireless communication systems may communicate over the Millimeter wave (mmWave) frequency band, e.g., the 60 GHz Frequency band. The mmWave frequency band has a few major distinctive features in comparison with lower frequency bands, e.g., the frequency bands of 2.4-5 GHz. For example, the mmWave frequency band may have a propagation loss greater than the propagation loss in the lower frequency bands, and may have Quasi-optical propagation properties.

A mmWave communication system may use high-gain directional antennas to compensate for large path loss and/or employ beam-steering techniques. Design of appropriate antenna systems and/or further signal processing may be an important aspect of mmWave communication system development.

Multi-element phased antenna arrays may be used, for example, for creation of a directional antenna pattern. A phased antenna array may form a directive antenna pattern or a beam, which may be steered by setting appropriate signal phases at the antenna elements.

Challenges exist in providing antenna systems that offer desired properties, e.g., gain and/or spatial coverage.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of an antenna array, in accordance with some demonstrative embodiments.

FIG. 3 is a schematic illustration of another antenna array, in accordance with some demonstrative embodiments.

FIGS. 4A, 4B and 4C are isometric, side and top views of a radiation pattern of an antenna module, in accordance with some demonstrative embodiments.

FIG. 4D schematically illustrates a composite beam generated by an antenna array, and FIGS. 4E and 4F, schematically illustrate a first beamforming (BF) scheme and a second BF scheme for steering the composite beam, in accordance with some demonstrative embodiments.

FIGS. 5A and 5B are schematic illustrations of a coverage area of an antenna array, in accordance with some demonstrative embodiments.

FIG. 5C schematically illustrates fine azimuth BF of a composite beam, in accordance with some demonstrative embodiments.

FIG. 5D schematically illustrates first and second azimuth coverage sectors, in accordance with some demonstrative embodiments.

FIG. 6 is a schematic illustration of a wireless communication unit, in accordance with some demonstrative embodiments.

FIG. 7 is a schematic illustration of a wireless communication unit for Orthogonal-Frequency-Division-Multiplexing (OFDM) communication, in accordance with some demonstrative embodiments.

FIG. 8 is a flow-chart illustration of a method of communicating via an antenna array, in accordance with some demonstrative embodiments.

FIG. 9 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, an Ultrabook™ computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12-TGac Channel Model Addendum Document”); IEEE 802.11 task group ad (TGad) (IEEE P802.11ad Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band)) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The phrase “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments may be used in conjunction with a WLAN. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), e.g., a frequency band within the frequency band of between 20 Ghz and 300 GHZ, a WLAN frequency band, a WPAN frequency band, a frequency band according to the WGA specification, and the like.

The phrase “peer to peer (PTP or P2P) communication”, as used herein, may relate to device-to-device communication over a wireless link (“peer-to-peer link”) between a pair of devices. The P2P communication may include, for example, wireless communication over a direct link within a QoS basic service set (BSS), a tunneled direct-link setup (TDLS) link, a STA-to-STA communication in an independent basic service set (IBSS), or the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements.

The phrase “mmWave frequency band” as used herein may relate to a frequency band above 20 GHz, e.g., a frequency band between 20 GHz and 300 GHz. The phrases “directional multi-gigabit (DMG)” and “directional band” (DBand), as used herein, may relate to a frequency band wherein the Channel starting frequency is above 40 GHz.

The phrases “DMG STA” and “mmWave STA (mSTA)” may relate to a STA having a radio transmitter, which is operating on a channel that is within the mmWave or DMG band.

The term “beamforming”, as used herein, may relate to a spatial filtering mechanism, which may be used at a transmitter and/or a receiver to improve one or more attributes, e.g., the received signal power or signal-to-noise ratio (SNR) at an intended receiver.

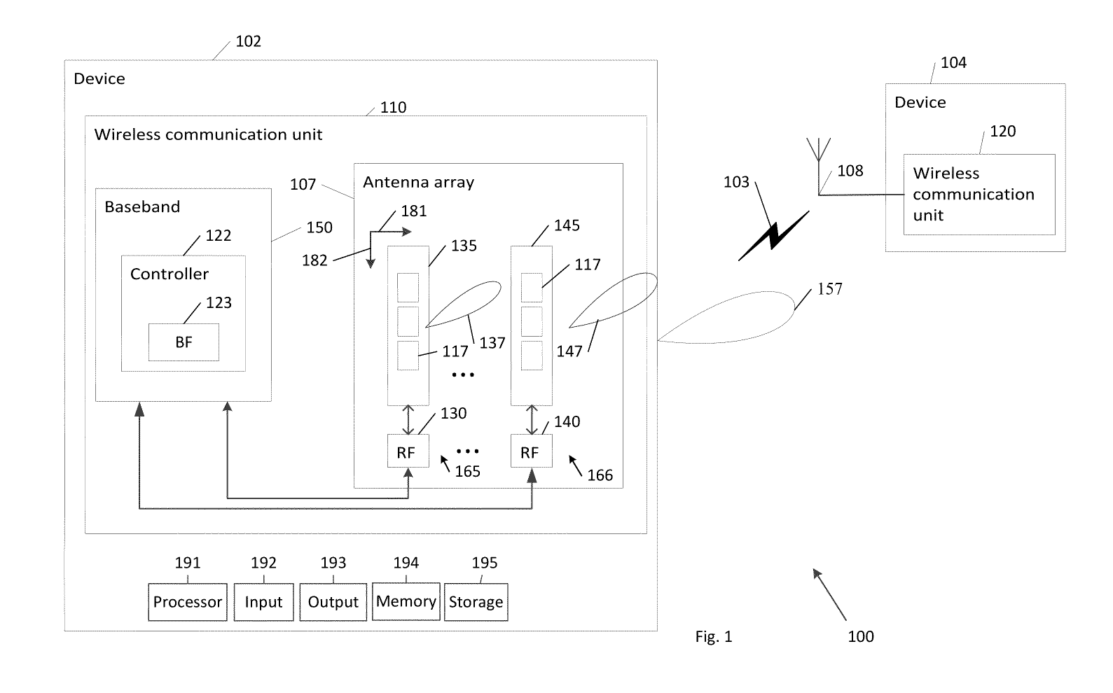

Reference is now made to FIG. 1, which schematically illustrates a block diagram of a system 100, in accordance with some demonstrative embodiments.

In some demonstrative embodiments, system 100 may include a wireless communication network including one or more wireless communication devices, e.g., wireless communication devices 102 and/or 104, capable of communicating content, data, information and/or signals over a wireless communication link, for example, over a radio channel, an IR channel, a RF channel, a Wireless Fidelity (WiFi) channel, and the like. One or more elements of system 100 may optionally be capable of communicating over any suitable wired communication links.

In some demonstrative embodiments, devices 102 and/or 104 may include a wireless communication unit capable of communicating content, data, information and/or signals over at least one wireless communication link 103. For example, device 102 may include a wireless communication unit 110, and device 104 may include a wireless communication unit 120. Wireless communication units 110 and/or 120 may include, for example, one or more wireless transmitters, receivers and/or transceivers able to send and/or receive wireless communication signals, RF signals, frames, blocks, transmission streams, packets, messages, data items, and/or data. For example, wireless communication units 110 and/or 120 may include or may be implemented as part of a wireless Network Interface Card (NIC), and the like.

In some demonstrative embodiments, wireless communication units 110 and/or 120 may include, or may be associated with, one or more antennas 107 and 108, respectively. Antennas 107 and/or 108 may be configured for transmitting and/or receiving wireless communication signals, blocks, frames, transmission streams, packets, messages and/or data. In some embodiments, antennas 107 and/or 108 may implement transmit and receive functionalities using separate transmit and receive antenna elements. In some embodiments, antennas 107 and/or 108 may implement transmit and receive functionalities using common and/or integrated transmit/receive elements.

In some demonstrative embodiments, antennas 107 and/or 108 may include an antenna array configured for generating one or more directional beams, for example, for communicating over one or more beamformed links, e.g., as described below.

In some demonstrative embodiments, antenna 108 may perform the functionality of an antenna array, e.g., similar to antenna array 107. In other embodiments, antenna 108 may include any other antenna configuration, structure and/or arrangement of one or more antenna elements, components, units, assemblies and/or arrays. For example, antenna 108 may include a phased array antenna, an omni-directional antenna, a single element antenna, a multiple element antenna, a set of switched beam antennas, and/or the like.

In some demonstrative embodiments, wireless communication devices 102 and/or 104 may include, for example, a PC, a desktop computer, a mobile computer, a laptop computer, a notebook computer, a tablet computer, an Ultrabook™ computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

Devices 102 and/or 104 may also include, for example, one or more of a processor 191, an input unit 192, an output unit 193, a memory unit 194, and a storage unit 195. Device 102 may optionally include other suitable hardware components and/or software components. In some demonstrative embodiments, some or all of the components of device 102 may be enclosed in a common housing or packaging, and may be interconnected or operably associated using one or more wired or wireless links. In other embodiments, components of device 102 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Liquid Crystal Display (LCD) display unit, a plasma display unit, one or more audio speakers or earphones, or other suitable output devices.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102.

In some demonstrative embodiments, wireless communication link 103 may include a direct link, e.g., a P2P link, for example, to enable direct communication between devices 102 and 104.

In some demonstrative embodiments, wireless communication link 103 may include a wireless communication link over the mmWave band, e.g., the DMG band or any other frequency band.

In some demonstrative embodiments, wireless communication devices 102 and/or 104 may perform the functionality of mmWave STAs, e.g., DMG stations (“DMG STA”). For example, wireless communication devices 102 and/or 104 may be configured to communicate over the DMG band.

In some demonstrative embodiments, wireless communication link 103 may include a wireless beamformed link.

In some demonstrative embodiments, wireless communication link 103 may include a wireless gigabit (WiGig) link. For example, wireless communication link 103 may include a wireless beamformed link over the 60 GHZ frequency band.

In other embodiments, wireless communication link 103 may include any other suitable link and/or may utilize any other suitable wireless communication technology.

In some demonstrative embodiments, antenna array 107 may include a plurality of antenna elements 117, which may be configured, for example, for creating a highly directional antenna pattern. The plurality of antenna elements 117 may be placed, for example, in an array, e.g., a two-dimensional array, of a predefined geometry, e.g., as described below. The plurality of antenna elements 117 may be configured to form one or more highly directive antenna patterns or beams, which may be steered by setting appropriate signal phases at antenna elements 117 and/or by baseband processing, e.g., as described below.

In some demonstrative embodiments, antenna array 107 may implement a modular antenna array architecture, e.g., as described below.

In some demonstrative embodiments, the modular antenna array architecture may be configured to provide a relatively large, e.g., a very large aperture, which may be suitable, for example, for communication over the mmWave frequency band.

In some demonstrative embodiments, wireless communication unit 110 may be configured to control antenna array 107 to generate and steer one or more beams to be directed to one or more other devices, e.g., including device 104. Wireless communication unit 110 may communicate with the other devices via one or more wireless communication links over the beams formed by antenna array 107, as described in detail below.

In some demonstrative embodiments, elements of system 100, e.g., devices 102 and/or 104, may utilize the mmWave communication band to provide wireless connectivity for a relatively large coverage area. In one example, elements of system 100 may be deployed, for example, in outdoor spaces, e.g., a street, a stadium, and the like, and/or large indoor areas, e.g., conference halls, and the like.

For example, system 100 may include a plurality of small cells, e.g., a large number of small cells, which may be deployed to cover the large coverage area. A cell may include a wireless communication node, e.g., a BS, which may be configured to cover and/or serve a relatively small number of users, for example, mobile devices, e.g., User Equipment (UE), and the like. The deployment of the small cells may provide, for example, high-speed wireless access for communication by many users, e.g., simultaneously.

In one example, device 102 may perform the functionality of a wireless communication node of a cell, which may serve one or more mobile devices, e.g., including device 104. For example, wireless communication device 102 may perform the functionality of a BS, a macro BS, a micro BS, an AP, a WiFi node or station, a WiGig node or station, a Wimax node or station, a cellular node, an evolved Node B (eNB), a pico eNB, an LTE node, a station, a hot spot, a network controller, and the like; and/or device 104 may perform the functionality of a mobile device, e.g., a UE.

In some demonstrative embodiments, device 102 may communicate with the mobile devices of the cell via a plurality of wireless communication links (“access links”). For example, device 102 may communicate with device 104 via a wireless access link, e.g., link 103. Link 103 may include a downlink for communicating downlink data from device 103 to device 104 and/or an uplink for communicating uplink data from device 104 to device 102.

In other embodiments, device 102 may perform the functionality of a UE, a mobile device, or any other wireless communication device.

In some demonstrative embodiments, antenna array 107 may include a plurality of antenna modules arranged along a first axis 181. For example, as shown in FIG. 1, antenna array 107 may include at least one row of antenna modules, e.g., including antenna modules 165 and 166 and/or any other number of antenna modules, e.g., more than two antenna modules.

The phrase “antenna module” as used herein may relate to an antenna sub-array coupled to a Radio-Frequency (RF) chain.

The phrase “antenna sub-array” as used herein may include a plurality of antenna elements, which are coupled to a common RF chain.

In one example, antenna module 165 may include a sub-array 135 of a first plurality of antenna elements 117, which may be coupled to a first common RF chain 130, and antenna module 166 may include a sub-array 145 of a second plurality of antenna elements 117, which may be coupled to a second common RF chain 140.

In some demonstrative embodiments, RF chain 130 may be configured to process signals communicated via antenna elements 117 of antenna sub-array 135; and/or RF chain 140 may be configured to process signals communicated via antenna elements 117 of antenna sub-array 145, e.g., as described below.

In some demonstrative embodiments, RF chain 130 may be configured to control phase shifts of antenna elements 117 of antenna sub-array 135; and/or RF chain 140 may be configured to control phase shifts of antenna elements 117 of antenna sub-array 145, e.g., as described below.

In some demonstrative embodiments, the antenna elements of antenna sub-arrays 135 and 145 may be arranged along a second axis 182, e.g., perpendicular to axis 181.

For example, as shown in FIG. 1, sub-array 135 may include at least one column of antenna elements 117, and sub-array 145 may include at least one column of antenna elements 117.

Some demonstrative embodiments are described herein with respect to an antenna array, e.g., antenna array 107, including a plurality of antenna modules, e.g., modules 165 and 166, arranged in at least one row, e.g., along axis 181, wherein an antenna sub-array of each antenna module, e.g., antenna sub-arrays 135 and 145, includes one or more columns of antenna elements, e.g., antenna elements 117, arranged along axis 182. However, in other embodiments, the antenna modules and/or antenna sub-arrays of an antenna array may be arranged according to any other orientation and/or coordinate system, e.g., a two-dimensional coordinate system. In one example, the antenna array may include at least one column of antenna modules, wherein an antenna module includes an antenna sub-array including one or more rows of antenna elements.

In some demonstrative embodiments, wireless communication unit 110 may include a controller 122 to control antenna array 107, e.g., as described below. In one example, controller 122 may be implemented as part of a baseband (BB) 150 of wireless communication unit 110, e.g., as described below.

In some demonstrative embodiments, wireless communication unit 110 may include a beamforming (BF) processor 123 to apply one or more beamforming processing techniques to process signals communicated by antenna array 107, e.g., as described below.

In some demonstrative embodiments, BF processor 123 may be implemented as part of BB 150, e.g., as part of controller 150. In other embodiments, BF processor 123 may be implemented as part of any other element of wireless communication unit 110, e.g., as part of an Intermediate-Frequency (IF) module of wireless communication unit 110, or as part of an RF module of wireless communication unit 110.

In some demonstrative embodiments, controller 122 may control antenna array 107 to form one or more directional beams for communicating data over one or more links 103.

In some demonstrative embodiments, controller 122 may control the plurality of antenna elements 117 of antenna module 135 to generate a directional beam 137, and/or the plurality of antenna elements 117 of antenna module 145 to generate a directional beam 147.

In some demonstrative embodiments, beams 137 and/or 147 may have a first beam-width in a first plane including axis 181 and perpendicular to axis 182, e.g., in a horizontal plane; and a second beam-width in a second plane including axis 182 and perpendicular to axis 181, e.g., a vertical plane.

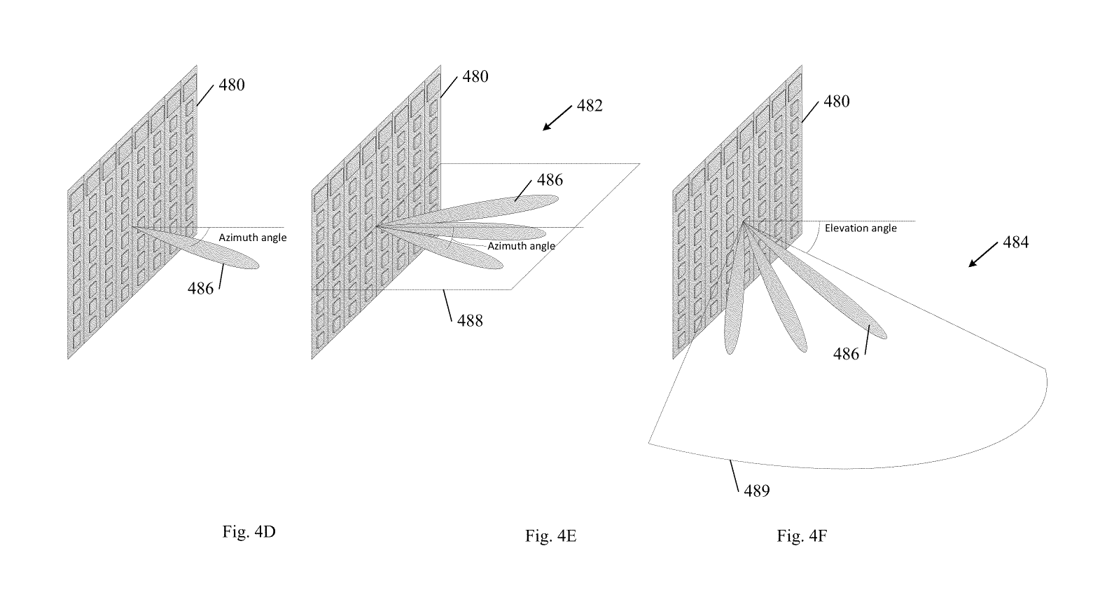

In some demonstrative embodiments, an aperture of antenna modules 135 and 145 in the first plane may be narrower than an aperture of antenna modules 135 and 145 in the second plane. Accordingly, the first beam-width of beams 137 and/or 147 in the horizontal plane may be wider than the second beam-width of beams 137 and/or 147 in the vertical plane, e.g., as described below with reference to FIGS. 4A, 4B and 4C.

In some demonstrative embodiments, controller 122 may control antenna array 107 to steer directional beams 137 and/or 147 along axis 182, e.g., in the vertical plane.

In some demonstrative embodiments, controller 122 may control antenna array 107 to steer directional beams 137 and/or 147 along axis 181, e.g., in the horizontal plane.

In some demonstrative embodiments, controller 122 may control antenna array 107 to steer directional beams 137 and/or 147 in a dual-axis manner, e.g., simultaneously in both the vertical and horizontal planes.

According to these embodiments, controller 122 may be configured to control both an azimuth, e.g., in the horizontal plane, and an elevation, e.g., in the vertical plane, of one or more directional beams formed by antenna array 107.

In some demonstrative embodiments, antenna array 107 may be configured to perform the functionality of a modular antenna array, e.g., a large antenna array having a large aperture, including a plurality of modular antenna elements, wherein each antenna sub-array of antenna array 107, e.g., the antenna sub-arrays of antenna modules 135 and 145, may perform the functionality of a modular antenna element of the plurality of modular antenna elements. For example, antenna array may generate at least one composite antenna beam 157, which may be formed by of a combination of the beams, e.g., beams 137 and 147, generated by the antenna modules, e.g., antenna modules 135 and 145, of antenna array 107, e.g., as described below.

In some demonstrative embodiments, antenna array 107 may be configured to perform the functionality of an adaptive antenna array composed of elements having variable directivity patterns. In one example, antenna array 107 may be configured to employ an antenna module of the antenna modules, e.g., each of antenna modules 135 and 145, to perform the functionality of an antenna element, e.g., analogous to an antenna element of a traditional antenna array.

In some demonstrative embodiments, the adaptive antenna array configuration of antenna array 107 may enable utilizing one or more Multi-Input-Multi-Output (MIMO) processing techniques, e.g., by BF processor 123, for example, for throughput enhancement purposes via, e.g., multi-user (MU) MIMO or single-user (SU) MIMO schemes, e.g., as described below.

In some demonstrative embodiments, the aperture of the modular antenna array in the horizontal plane may be much larger than the aperture of each of modules 135 and 145, e.g., since modules 135 are arranged along axis 181. For example, a narrowest beam-width of composite beam 157 in the horizontal plane that may be produced by the modular antenna array may be m times narrower than the beam-width in the horizontal plane of the beam produced by a single antenna module of modules 135 and 145, wherein m denotes a number of antenna modules included in antenna array 107.

In some demonstrative embodiments, a relationship between the beam-width of the composite beam 157 in the horizontal plane and the beam-width of the composite beam 157 in the vertical plane may be based on a relationship between the number m of antenna modules and a number, denoted n, of antenna elements 117 included in each antenna module.

In one example, the composite beam 157 may have substantially the same beam-width in both horizontal and vertical planes, for example, if the number m is equal to the number n, e.g., if antenna array 107 includes m=8 antenna modules, each having n=8 antenna elements, and the antenna elements 117 are equally spaced along both axes 181 and 182.

In another example, the beam-width of the composite beam 157 in the horizontal plane may be narrower than the beam-width of the composite beam 157 in the vertical plane, for example, if the number m is greater than the number n, e.g., if antenna array 107 includes m=32 antenna modules, each having n=8 antenna elements, and the antenna elements 117 are equally spaced along both axes 181 and 182.

In some demonstrative embodiments, controller 122 may control the plurality of antenna modules of antenna array 107, e.g., antenna modules 135 and 145, to generate a plurality of directional beams, e.g., directional beams 137 and 147, for communicating a beamformed diversity wireless transmission over a plurality of beamformed links.

In some demonstrative embodiments, the beamformed diversity wireless transmission may include a Multi-Input-Multi-Output (MIMO) transmission.

Some demonstrative embodiments are described herein with reference to a wireless communication unit, e.g., wireless communication unit 110, configured to perform both transmission and reception of a MIMO beamformed communication. Other embodiments may include a wireless communication unit capable of performing only one of transmission and reception of a MIMO beamformed communication.

The phrase “beamformed diversity communication”, as used herein may relate to a communication utilizing a plurality of beams.

Some demonstrative embodiments are described herein with reference to a communication system, e.g., wireless communication system 100, wherein both a Transmit (TX) side and a Receive (RX) side, e.g., devices 102 and 104, utilize an antenna array to communicate a MIMO transmission. However, other embodiments may be implemented with respect to systems configured to communicate any other diversity communication, for example, systems in which only one of the Tx and Rx sides utilizes a multi-beam transceiver, e.g., to form a Single-Input-Multi-Output (SIMO) and/or a Multi-Input-Single-Output (MISO) beamformed link. For example, one of the Tx and Rx sides may utilize an omni-directional antenna, and another one of the Tx and Rx sides may utilize a multi-beam transceiver, e.g., wireless communication unit 110.

In some demonstrative embodiments, the beamformed diversity wireless transmission may include a Single-User (SU) MIMO transmission, e.g., as described below.

In some demonstrative embodiments, the beamformed diversity wireless transmission may include a Multi-User (MU) MIMO transmission, e.g., as described below.

In some demonstrative embodiments, the directivity patterns of the antenna-module of antenna array 107 may be used for coverage extension purposes, e.g., as described below.

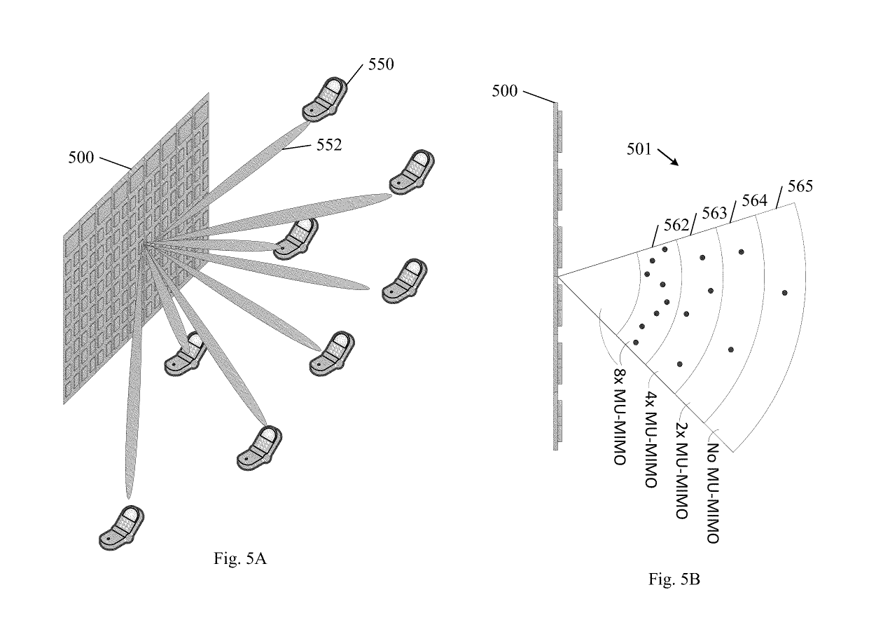

In some demonstrative embodiments, controller 122 may control antenna array 107 to steer the plurality of directional beams between a plurality of coverage areas. For example, controller 122 may control antenna array 107 to steer the plurality of directional beams to cover a sector including a plurality of users, and to perform a MU-MIMO communication with the users, e.g., as described below with reference to FIGS. 5A and 5B. Controller 122 may control antenna array 107 to steer the plurality of directional beams between a plurality of different sectors covering different pluralities or groups of users.

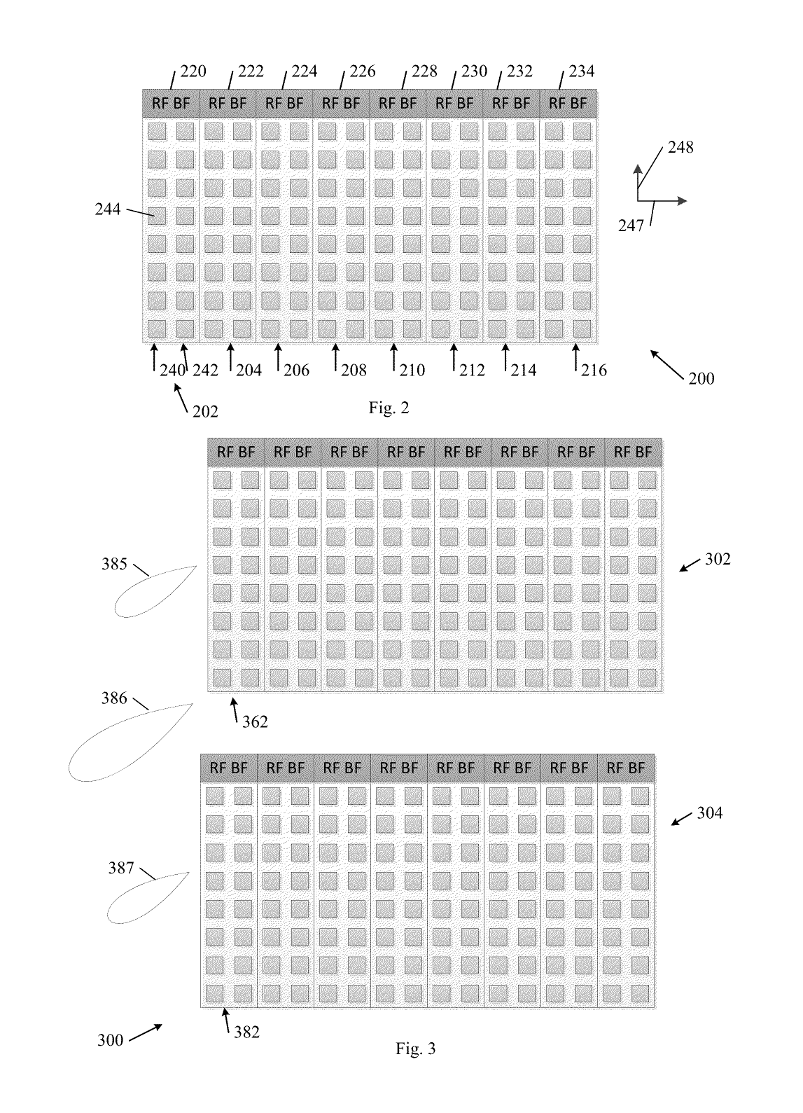

Reference is now made to FIG. 2, which schematically illustrates an antenna array 200, in accordance with some demonstrative embodiments. For example, antenna array 200 may perform the functionality of antenna array 107 (FIG. 1).

In some demonstrative embodiments, antenna array 200 may include a two-dimensional array of antenna elements formed by an array of antenna modules. For example, as shown in FIG. 2, the two-dimensional array of antenna elements may be formed by an array of vertically oriented antenna modules.

In some demonstrative embodiments, antenna array 200 may include at least one row of antenna modules, wherein each antenna module includes an antenna sub-array having at least one column of antenna elements.

For example, as shown in FIG. 2, antenna array 200 may include a row of eight antenna modules 202, 204, 206, 208, 210, 212, 214 and 216, which may be concatenated, for example, along a horizontal axis 247. Each of antenna modules 202, 204, 206, 208, 210, 212, 214 and 216 may include an antenna sub-array including two columns of antenna elements 244, which may be arranged, for example, along a vertical axis 248. For example, as shown in FIG. 2, antenna module 202 may include a first column 240 of eight antenna elements 244 and a second column 242 of eight antenna elements.

According to the example shown in FIG. 2, antenna array 200 may include 128 antenna elements 244 arranged in a two-dimensional array of 8 rows and 16 columns. In other embodiments, an antenna array may include any other number of antenna elements arranged in any other number of columns within any other number of antenna modules.

In some demonstrative embodiments, the antenna elements 244 of an antenna module of array 200 may be coupled to a common RF chain. For example, as shown in FIG. 2, the sixteen antenna elements 244 of antenna module 202 may be coupled to a common RF chain 220; the sixteen antenna elements 244 of antenna module 204 may be coupled to a common RF chain 222; the sixteen antenna elements 244 of antenna module 206 may be coupled to a common RF chain 224; the sixteen antenna elements 244 of antenna module 208 may be coupled to a common RF chain 226; the sixteen antenna elements 244 of antenna module 210 may be coupled to a common RF chain 228; the sixteen antenna elements 244 of antenna module 212 may be coupled to a common RF chain 230; the sixteen antenna elements 244 of antenna module 214 may be coupled to a common RF chain 232; and the sixteen antenna elements 244 of antenna module 216 may be coupled to a common RF chain 234.

In some demonstrative embodiments, antenna modules 202, 204, 206, 208, 210, 212, 214 and 216 may be capable of generating a plurality of directional beams, e.g., up to eight directional beams.

In some demonstrative embodiments, the vertical orientation of antenna modules 202, 204, 206, 208, 210, 212, 214 and 216 may enable steering the plurality of beams in a vertical plane, e.g., along vertical axis 248. The steering of the beams in the vertical plane may be performed, for example, by RF beamforming, which may be controlled by RF chains 220, 222, 224, 226, 228, 230, 232 and 234. For example, RF chain 220 may control antenna module 202 to generate a directional beam, which may be steerable in the vertical plane, for example, by adjusting phase shifts applied by RF chain 220 to antenna elements 244 of columns 240 and/or 242.

In some demonstrative embodiments, an antenna array, e.g., antenna array 200, may include a single row of antenna modules, e.g., antenna modules 202, 204, 206, 208, 210, 212, 214 and/or 216, wherein each antenna module includes a sub-array of one or more columns, e.g., two columns, of antenna elements, e.g., antenna elements 244, coupled to a common RF chain.

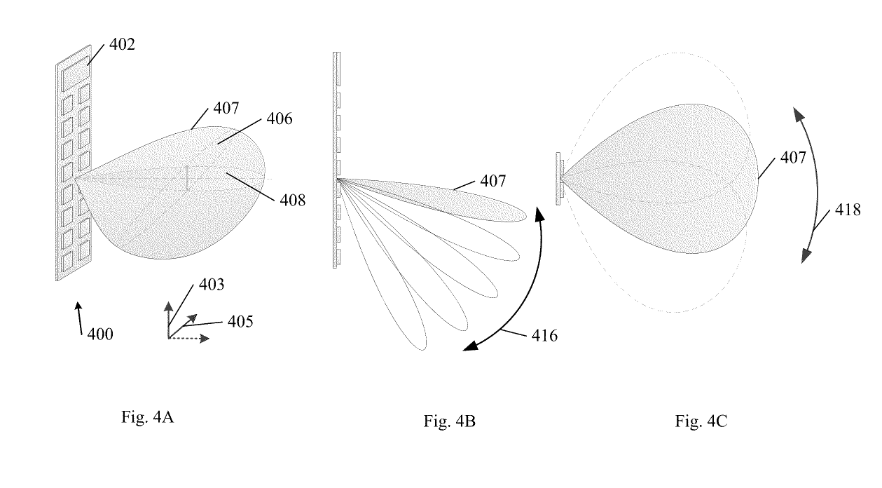

However, in other embodiments, the antenna array may include any other number of rows of antenna modules, and/or each antenna module may include an antenna sub-array including any other number of columns of antenna elements, e.g., one or more columns. In one example, the antenna array may include two or more rows of antenna modules, e.g., as described below with reference to FIG. 3.

Reference is now made to FIG. 3, which schematically illustrates an antenna array 300, in accordance with some demonstrative embodiments. For example, antenna array 300 may perform the functionality of antenna array 107 (FIG. 1).

In some demonstrative embodiments, antenna array 300 may include a two-dimensional array of antenna elements formed by an array of antenna modules.

In some demonstrative embodiments, antenna array 300 may include two or more sets of antenna modules arranged along two or more parallel lines, e.g., in parallel to a horizontal axis.

For example, as shown in FIG. 3, the two-dimensional array of antenna elements may be formed by a first row 302 and a second row 304 of vertically oriented antenna modules.

In some demonstrative embodiments, each of rows 302 and 304 may include a row of antenna modules, wherein each antenna module includes an antenna sub-array having at least one column of antenna elements. In one example, each of rows 302 and 304 may include a row of eight antenna modules, which may be concatenated, for example, along a horizontal axis; each antenna module may include an antenna sub-array including two columns of antenna elements, which may be arranged, for example, along a vertical axis; and/or each antenna sub-array may be coupled to a common RF chain, e.g., as described above with reference to FIG. 2.

In some demonstrative embodiments, a multi-row arrangement of the antenna modules, e.g., as shown in FIG. 3, may be utilized for steering, e.g., in a fine manner, a plurality of directional beams in the vertical plane.

For example, coarse steering of the beams in the vertical plane may be performed, for example, by RF beamforming, e.g., as described above with reference to FIG. 2.

In some demonstrative embodiments, antenna array 300 may generate a steerable composite beam, e.g., composite beam 157 (FIG. 1), formed by at least two beams, which may be generated by a pair of antenna modules, including an antenna module of each of rows 302 and 304, located along a line parallel to the vertical axis.

For example, controller 122 (FIG. 1) may control antenna array 300 to generate a steerable composite beam 386, which may be formed by a combination of a pair of beams generated by a pair of antenna modules, e.g., a beam 385 generated by an antenna module 362 of row 302, and a beam 387 generated by an antenna module 382 of row 304.

According to these embodiments, coarse steering of composite beam 386 may be achieved by RF beamforming at the RF chains of antenna modules 362 and 382; and fine steering of composite beam 386 may be achieved by BB beamforming, e.g., BF processor 123 (FIG. 1), for example, utilizing any suitable MIMO processing schemes, e.g., to achieve a desired, aperture gain and/or power.

According to the demonstrative embodiments of FIG. 3, antenna array 3 may be capable of generating and steering eight composite beams in the vertical plane. For example, the eight composite beams may be generated by eight pairs of antenna modules, e.g., each pair of antenna modules including an antenna module of each of rows 302 and 304, located along a line parallel to the vertical axis.

Reference is now made to FIGS. 4A, 4B and 4C which schematically illustrate isometric, side and top views of a radiation pattern of a beam 407 generated by an antenna module 400, in accordance with some demonstrative embodiments. In one example, radiation pattern 404 may represent a radiation pattern of an individual antenna module of an antenna array, e.g., antenna array 107 (FIG. 1), antenna array 200 (FIG. 2) and/or antenna array 300 (FIG. 3). For example, antenna module 400 may perform the functionality of an antenna module of antenna modules 165 (FIG. 1), 166 (FIG. 1), 202 (FIG. 2), 204 (FIG. 2), 206 (FIG. 2), 208 (FIG. 2), 210 (FIG. 2), 212 (FIG. 2), 214 (FIG. 2), 216 (FIG. 2), 362 (FIG. 3) and 382 (FIG. 3).

In some demonstrative embodiments, the radiation pattern of beam 407 may have a first beam-width 408 in a first plane, e.g., a vertical plane, including an axis, e.g., a vertical axis 403, parallel to the one or more columns of antenna elements of antenna module 400.

In some demonstrative embodiments, the radiation pattern of beam 407 may have a second beam-width 406 in a second plane, e.g., a horizontal plane, including an axis, e.g., a horizontal axis 405, perpendicular to the one or more columns of antenna elements of antenna module 400.

In some demonstrative embodiments, beam-width 408 may be relatively narrow, e.g., in the vertical plane, and beam-width 406 may be relatively wide, e.g., in the horizontal plane.

In some demonstrative embodiments, the beam generated by antenna module 400 may be steered in both horizontal and vertical directions. For example, as shown in FIG. 4B, the beam 407 generated by module 400 may be steered in a vertical direction 416. As shown in FIG. 4C, the beam 407 generated by module 400 may be steered in a horizontal direction 418.

In some demonstrative embodiments, the steering of the beam formed by antenna module 400 may be controlled, for example, by RF beamforming at the RF chain 402 of antenna module 400 and/or by BB beamforming, e.g., at BF processor 123 (FIG. 1).

In some embodiments, the beamforming in the vertical plane may be mostly, e.g., even entirely, performed by the RF beamforming circuits in antenna module 400, for example, if an antenna array includes a single row of antenna modules, e.g., as described above with reference to FIG. 2.

In some demonstrative embodiments, some of the beamforming in the vertical plane, e.g., coarse beamforming, may be performed by the RF beamforming circuits in antenna module 400, and some of the beamforming in the vertical plane, e.g., fine beamforming, may be performed by BF processor 123 (FIG. 1), for example, if an antenna array includes a plurality of rows of antenna modules, e.g., as described above with reference to FIG. 3.

In some demonstrative embodiments, antenna module 400 may produce a relatively wide beam in the horizontal plane, e.g., as shown in FIGS. 4A and 4C.

In some demonstrative embodiments, the relatively wide beam-width 406 in the horizontal plane may enable utilizing each antenna module 400, or even a column of antenna elements of module 400, as an “antenna element” of a multi-element modular antenna array.

In some demonstrative embodiments, antenna module 400 may be controlled to provide a variable directivity pattern in the horizontal plane, e.g., if antenna module 400 includes more than one column of antenna elements, e.g., two columns of antenna elements 240 and 242 (FIG. 2).

In some demonstrative embodiments, this modular antenna array configuration may enable performing beamformed diversity communication in the horizontal plane, e.g., utilizing a plurality of directional beams, formed in the horizontal plane.

In some demonstrative embodiments, BF processor 123 (FIG. 1) may process signals communicated via antenna array 107 (FIG. 1) according to any suitable multi-antenna processing schemes and/or techniques, e.g., to achieve the beamformed diversity in the horizontal plane. The multi-antenna processing techniques may include, for example, beam steering, interference suppression, single-user or multi-user MIMO, and the like.

In some demonstrative embodiments, wireless communication unit 110 (FIG. 1) may be configured to communicate the beamformed diversity communication via antenna array 107 (FIG. 1) according to a MU-MIMO scheme. It may be beneficial to utilize the MU-MIMO scheme for communication over the mmWave frequency band, for example, due to the nature of signal propagation in the mmWave band, e.g., which may be characterized by a strong Line-of-Sight (LOS) component, sharp shadowing and/or weak multi-path components in the channel.

Reference is now made to FIG. 4D, which schematically illustrates a composite beam 486 generated by an antenna array 480, and FIGS. 4E and 4F, which schematically illustrate a first beamforming (BF) scheme 482 and a second BF scheme 484 for steering composite beam 486, in accordance with some demonstrative embodiments. In one example, antenna array may perform the functionality of antenna array 107 (FIG. 1).

In some demonstrative embodiments, composite beam 486 may be formed as a combination of beams generated by a plurality of antenna modules of antenna array 480, e.g., as described above.

In some demonstrative embodiments, antenna array 480 may steer composite beam 486 by performing BF in a direction (“vertical BF” or “elevation BF”)) along a vertical axis of array 480, e.g., axis 182 (FIG. 1), for example, by RF chains of the antenna modules, e.g. RF chains 130 and 140 (FIG. 1). Additionally or alternatively, antenna array 480 may steer composite beam 486 by performing BF in a direction (“horizontal BF” or “azimuth BF”) along a horizontal axis of array 480, e.g., axis 181 (FIG. 1), for example, by BF processor 123 (FIG. 1), e.g., as described below.

In some demonstrative embodiments, the azimuth BF may be performed by BF processor 123 (FIG. 1), for example, while applying substantially the same elevation BF. For example, controller 122 (FIG. 1) may control RF chains 130 and 140 (FIG. 1) to steer beams 137 and 147 (FIG. 1) in substantially the same elevation angle, while BF processor 123 (FIG. 1) applies the azimuth BF.

In one example, as shown in FIG. 4E, composite beam 486 may be steered within a an azimuth surface, which may take the form of a plane (“horizontal plane”) 488 perpendicular to antenna array 480, for example, by applying a zero elevation angle with respect to an antenna bore sight of antenna array 480.

In another example, as shown in FIG. 4F, the “horizontal plane” may take the form of a conical surface 489 corresponding to the elevation angle, for example, if a non-zero elevation angle is applied.

In some demonstrative embodiments, schemes 482 and/or 484 may be utilized for MU-MIMO in the azimuth surface, e.g., surfaces 488 and/or 489. For example, all antenna modules of antenna array 480 may be controlled, e.g., by controller 123 (FIG. 1), to apply the same elevation BF. As a result, all beams created by the antenna modules in azimuth may have the same elevation angle, with different, e.g., independent, azimuth angles.

In some demonstrative embodiments, the total power radiated by array 480 may be limited. Therefore, the lesser beams are created the more power may be allocated to each individual beam. Accordingly, less beams may be used, e.g., if increased power is required, e.g., to reach users at a far distance from antenna array 480, e.g., as described below with reference to FIG. 5B.

Reference is now made to FIGS. 5A and 5B, which schematically illustrate a coverage area of an antenna array 500, in accordance with some demonstrative embodiments. For example, antenna array 500 may perform the functionality of antenna array 107 (FIG. 1), antenna array 200 (FIG. 2), antenna array 300 (FIG. 3), and/or antenna array 480 (FIGS. 4C, 4D and 4E).

In some demonstrative embodiments, antenna array 500 may be controlled, e.g., by controller 122 (FIG. 1), to communicate a beamformed diversity communication utilizing a plurality of beams 552 directed to a plurality of users 550. In one example, antenna array 500 may be implemented as part of a base station (BS), an access point (AP), a node, and the like; and/or users 550 may include UE, e.g., mobile devices.

In some demonstrative embodiments, the number of users 550 which may be simultaneously served by antenna array 500 according to a MU-MIMO scheme may be based, for example, at least on channel qualities between antenna array 500 and each of the users 550, e.g., assuming that antenna array 500 has enough antenna elements to support a required number of spatial streams to be directed to the users 550. For example, the better the channel qualities, the more users may be served.

In some demonstrative embodiments, the channel quality between antenna array 500 and a user 550 may depend, for example, on a distance between the user and antenna array 500, as well as antenna gains and/or beam steering techniques applied to antenna array 500, e.g., assuming the user 550 utilizes a relatively omni-directional antenna to communicate with antenna array 500.

FIG. 5B illustrates a number of MU-MIMO coverage ranges, which may be achieved by antenna array 500, in accordance with some demonstrative embodiments.

As shown in FIG. 5B, a first number of users 550 may be simultaneously served, e.g., by a single BS, for example, within a first area 562, which may be at a first distance from antenna array 500, e.g., relatively close to antenna array 500. In one example, as shown in FIG. 5B, up to eight users 550 may be simultaneously served within area 562, for example, if antenna array 500 includes at least one row of eight antenna modules, e.g., as described above with reference to FIGS. 2 and/or 3.

In some demonstrative embodiments, the number of users 550 which may be simultaneously served may decrease, e.g., as the distance from antenna array increases. For example, as shown in FIG. 5B, up to a second number of users 550, which may be lesser than the first number of users, e.g., up to four users 550, may be simultaneously served by antenna array 550, within an area 563, which may be at a second distance, greater than the first distance, from antenna array 500; up to a third number of users 550, which may be lesser than the second number of users, e.g., up to two users 550, may be simultaneously served by antenna array 550, within an area 564, which may be at a third distance, greater than the second distance, from antenna array 500; and/or only SU-MIMO communication may be performed within an area 565, which may be at a fourth distance, greater than the third distance, from antenna array 500.

In some demonstrative embodiments, a shape of the area where MU-MIMO is supported may be determined by the horizontal directivity pattern of an antenna module, e.g., antenna module 400 (FIG. 4A), of antenna array 500. Accordingly, the MU-MIMO coverage area of antenna array 500 may have a shape of a sector 501, e.g., as shown in FIG. 5B.

In some demonstrative embodiments, the directivity pattern of antenna module 400 (FIG. 4A), and the RF beamforming settings of antenna module 400 (FIG. 4A), e.g., as controlled by RF chain 402 (FIG. 4A), may define sector 501. The MU-MIMO communication scheme may be achieved, for example, via beamforming of the entire composite modular antenna array 500, e.g., by BF processor 123 (FIG. 1).

In some demonstrative embodiments, sector 501 may be re-oriented, for example, via RF beamforming, e.g., of RF chain 402 (FIG. 4A), to serve, for example, users 550 in a different area. In addition, controller 122 (FIG. 1) may apply a time division for duplexing communications between two or more different areas or sectors. Accordingly, re-orientation of the sector 501 may not directly enhance the throughput via spatial multiplexing. Instead, re-orientation of the serving sector 501 can be used to select a set, e.g., an optimal set, of users for MU-MIMO operation.

In some demonstrative embodiments, antenna array 500 may be implemented by a BS, which may be placed at some height above the ground, e.g. mounted on a roof, lamp-post, or near a ceiling of a shopping mall. Communicating with users placed at different distances from the BS may require the BS to apply different elevation angles, e.g., as described above with reference to FIG. 4F.

In some demonstrative embodiments, it may be efficient to simultaneously serve only the users that have substantially similar distance from the BS, e.g., since for efficient beamforming in azimuth all antenna modules should apply substantially the same elevation angle, as discussed above. Accordingly, the BS may use the elevation angle to select such users form the plurality of the users in the cell.

In some demonstrative embodiments, a narrower azimuth beam-width may be achieved, for example, by utilizing an antenna array having a configuration (“multi-column configuration”) including a plurality of columns of antenna elements per antenna module, e.g., as described above with reference to FIGS. 2 and/or 3.

In some demonstrative embodiments, the multi-column configuration may be utilized for performing fine azimuth BF, e.g., by BF processor 123 (FIG. 1). For example, all antenna modules may be controlled, e.g., by controller 130 (FIG. 1), to steer a plurality of beams, e.g., including at least corresponding beams from different sub-array modules, in substantially the same direction. Different fine BF settings may be applied, e.g., by BF processor 123 (FIG. 1), to steer a composite beam formed by the plurality of beams in azimuth within the boundaries of the azimuth beam width of a single antenna module.

FIG. 5C schematically illustrates fine azimuth BF of a composite beam 570, in accordance with some demonstrative embodiments. For example, composite beam 570 may be generated by an antenna array 571 having a multi-column configuration, e.g., as described above with reference to FIGS. 2 and/or 3.

In some demonstrative embodiments, composite beam 570 may be generated by controlling all antenna modules of antenna array 571 to steer a plurality of beams in the antenna bore sight direction. Different directions of beam 570 may be obtained, for example, by applying different BF settings, e.g., at BF processor 123 (FIG. 1). An area 572 between the azimuth steering boundaries may be viewed as a sector, which may be steered by changing the RF azimuth BF settings of all antenna modules.

In some demonstrative embodiments, composite beam 570 may be steered by the RF chains of the antenna array 571, e.g., without involving the fine beamforming, for example, if a single composite beam is created and the RF phase shifters have substantial accuracy of phase shifting, e.g. several degrees. However, this configuration may require much more complex RF phase shifters and, therefore, may be less suitable for creation of multiple beams carrying different data.

In some demonstrative embodiments, antenna array 571 may be able to steer coverage sector 572, e.g., as described below.

Reference is also made to FIG. 5D, which schematically illustrates a first sector 582 and a second sector 584, in accordance with some demonstrative embodiments. As shown in FIG. 5D, antenna array 571 may be able to steer the coverage sector, e.g., between coverage sectors 582 and 583, for example, by changing RF BF settings the modular antenna array.

In some demonstrative embodiments, the RF and BB beamforming algorithms may be coordinated. It is possible that BF processor 123 (FIG. 1) may try to steer a composite beam in a direction, which is out of the sector covered by RF azimuth beamforming. For example, BF processor 123 (FIG. 1) may try to steer the composite beam in the direction within the Sector 582, whereas the RF azimuth BF settings of the antenna modules of array 571 may direct the beams of the antenna modules in the direction of Sector 584. In such a case the result of the beamforming may be hardly predictable and/or the resulting beam may have a power considerably lesser than if the azimuth BF settings of the RF chains and BF processor 123 (FIG. 1) were coordinated.

In some demonstrative embodiments, in some circumstances, e.g., due to user motion, it may be difficult to find the required number of users placed at substantially the same distance from the BS and placed in such a way that allows creating independent beams for each of the users that would suppress interference between the user's transmissions. In these circumstances, a modular antenna array having the multi-column configuration, e.g., as described above with reference to FIGS. 2 and/or 3, may provide an advantage, for example, as the multi-column configuration may enable the antenna array to adjust the coverage sector by adjusting the azimuth RF BF settings in the antenna modules. Therefore, the antenna array may have more chances to find a group of users of appropriate size that could be served simultaneously at the given distance.

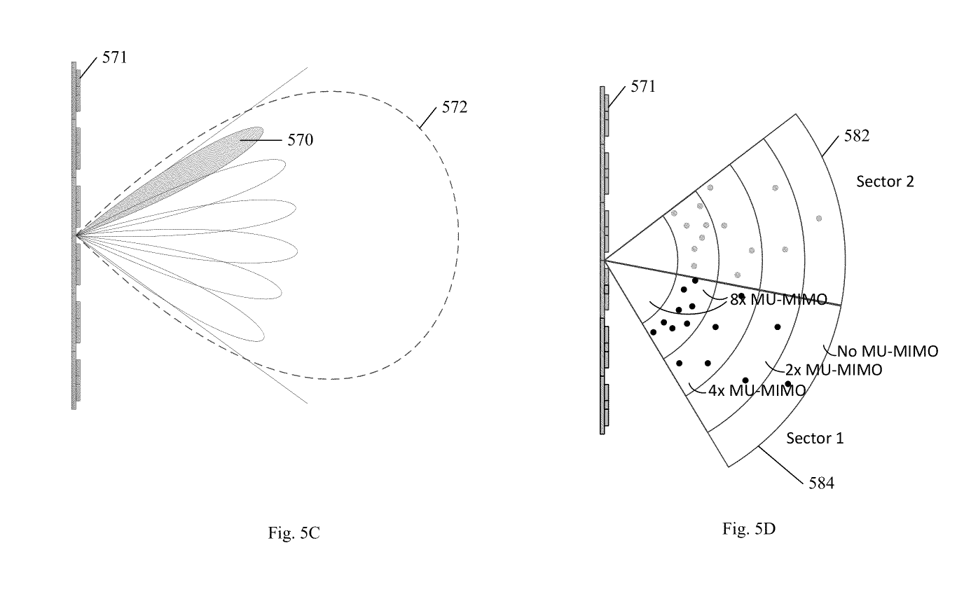

Reference is now made to FIG. 6, which schematically illustrates a wireless communication unit 600, in accordance with some demonstrative embodiments. In some demonstrative embodiments, wireless communication unit 600 may perform the functionality of wireless communication unit 110 (FIG. 1) and/or wireless communication unit 120 (FIG. 1).

In the demonstrative embodiments of FIG. 6, wireless communication unit 600 may communicate a MU-MIMO communication including a first data stream 661 communicated with a first user and a second data stream 663 communicated with a second user. For example, device 104 (FIG. 1) may perform the functionality of one of the first and second users. In other embodiments, wireless communication unit 600 may be configured to communicate a MU-MIMO communication with any other number of users.

In some demonstrative embodiments, wireless communication unit 600 may include a BB processing unit 603 coupled to a plurality of antenna modules 601, e.g., three antenna modules or any other number of antenna modules.

In some demonstrative embodiments, BB processing unit 603 may include two coding and modulation modules 662 to process data streams 661 and 663. For example, a module 662 may include at least a forward error correction module 671 and a modulation mapping module 672.

In some demonstrative embodiments, BB processing unit 603 may include a MIMO encoder/decoder 640 to apply fine beamforming processing to the signals processed by modules 662, e.g., as described above.

In some demonstrative embodiments, MIMO encoder/decoder 640 may process the streams 661 and 663 such that each stream is transmitted via a combination of antenna modules 601.

In some demonstrative embodiments, BB processing unit 603 may include a plurality of BB processing chains 630 to process BB signals to be transmitted via antenna modules 601. For example, each baseband processing chain 630 may process a combination of signals derived from both data streams 661 and 663.

In some demonstrative embodiments, BB processing unit 603 may include a central BF controller 623 configured to control the BB BF applied by MIMO encoder/decoder 640 and the RF BF applied by antenna modules 601, e.g., as described above. For example, controller 623 may control BF weights applied to the MIMO transmission. In one example, controller 623 may perform the functionality of controller 122 (FIG. 1).

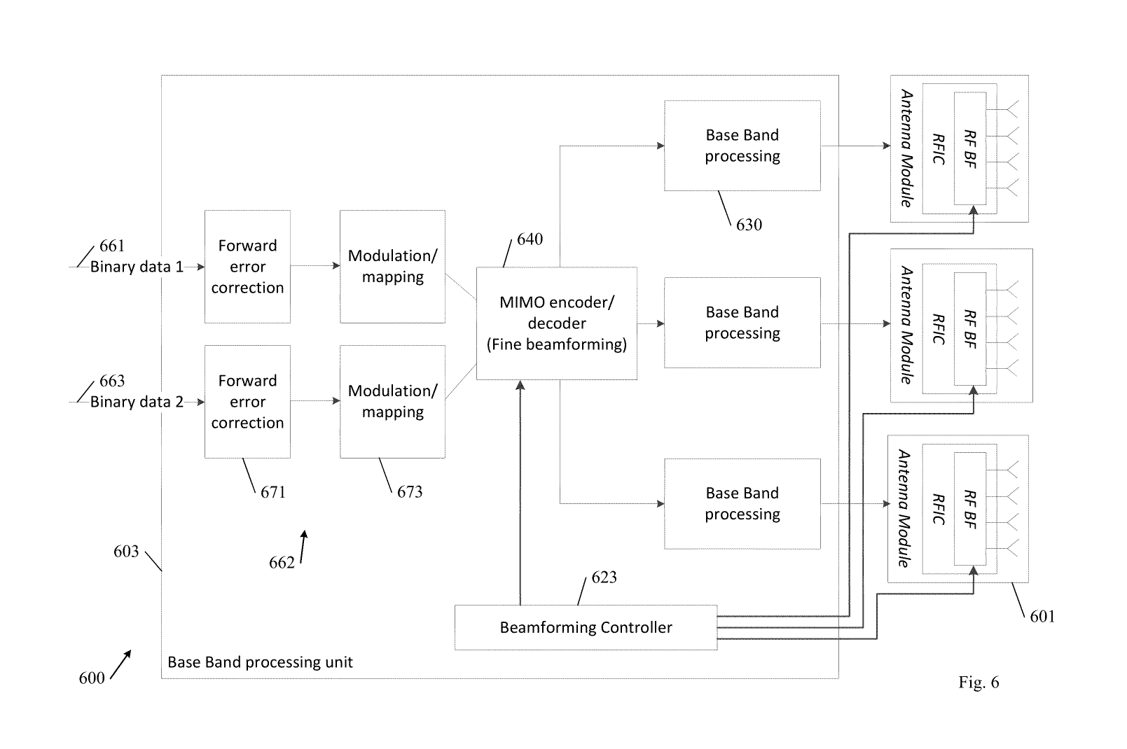

Reference is now made to FIG. 7, which schematically illustrates a wireless communication unit 700 for Orthogonal-Frequency-Division-Multiplexing (OFDM) communication, in accordance with some demonstrative embodiments. In some demonstrative embodiments, wireless communication unit 700 may perform the functionality of wireless communication unit 110 (FIG. 1) and/or wireless communication unit 120 (FIG. 1). In one example, wireless communication unit may perform the functionality of wireless communication unit 600 (FIG. 6).

In the demonstrative embodiments of FIG. 7, wireless communication unit 700 may communicate a MU-MIMO communication including a first data stream 761 communicated with a first user and a second data stream 763 communicated with a second user. For example, device 104 (FIG. 1) may perform the functionality of one of the first and second users. In other embodiments, wireless communication unit 700 may be configured to communicate a MU-MIMO communication with any other number of users.

In some demonstrative embodiments, wireless communication unit 700 may include a RF portion 701 coupled to a BB portion 703, e.g., as described below.

In some demonstrative embodiments, wireless communication unit 700 may include an antenna array including a plurality of antenna sub-arrays coupled to a plurality of RF chains. For example, as shown in FIG. 7, wireless communication unit 700 may include an antenna sub-array 702 coupled to an RF chain 712, an antenna sub-array 704 coupled to an RF chain 714, an antenna sub-array 706 coupled to an RF chain 716, and an antenna sub-array 708 coupled to an RF chain 718. In other embodiments, wireless communication unit 700 may include any other number of antenna modules, antenna sub-arrays and/or RF chains.

In some demonstrative embodiments, antenna sub-arrays 702, 704, 706 and 708 may be arranged in a row along a horizontal axis, e.g., axis 181 (FIG. 1), e.g., as described above.

In some demonstrative embodiments, each of antenna sub-arrays 702, 704, 706 and/or 708 may include one or more columns of antenna elements 717. For example, as shown in FIG. 7, each of antenna sub-arrays 702, 704, 706 and/or 708 may include two columns of antenna elements 717 arranged long a vertical axis, e.g., as described above.

In some demonstrative embodiments, RF chains 712, 714, 716 and/or 718 may be configured to control the antenna elements 717 of antenna sub-arrays 702, 704, 706 and 708.

In some demonstrative embodiments, RF chains 712, 714, 716 and/or 718 may include or may be included as part of a radio frequency integrated circuit (RFIC), which may be connected to antenna sub-arrays 702, 704, 706 and/or 708 through a plurality of feed lines 715, which may be, for example, micro-strip feed lines.

In some demonstrative embodiments, RF chains 712, 714, 716 and 718 may enable processing of four independent RF signals, e.g., carrying different data. For example, RF chain 712 may process an RF signal 723, RF chain 714 may process an RF signal 725, RF chain 716 may process an RF signal 727, and RF chain 718 may process an RF signal 729.

In some demonstrative embodiments, RF chains 712, 714, 716 and 718 may include a plurality of phase shifters 713 configured to adjust the phases of the antenna elements of antenna sub-arrays 702, 704, 706 and 708. For example, a phase shifter of phase shifters 713 may be configured to adjust a phase of a corresponding antenna element 717. In one example, the phase shifters 713 of RF chains RF chains 712, 714, 716 and 718 may be controlled by a controller, e.g., controller 122 (FIG. 1) or controller 623 (FIG. 6).

For example, phases of the antenna elements 717 of antenna subarray 702 may be shifted, e.g., by phase shifters 713 of RF chain 712, to provide a constructive and/or destructive interference, configured to change the beamforming scheme of antenna subarray 702 and to change the direction of a directional beam generated by antenna sub-array 702. Phases of the antenna elements 717 of antenna subarray 704 may be shifted, e.g., by phase shifters 713 of RF chain 714, to provide a constructive and/or destructive interference, configured to change the beamforming scheme of antenna subarray 704 and to change the direction of a directional beam generated by antenna sub-array 704. Phases of the antenna elements 717 of antenna subarray 706 may be shifted, e.g., by phase shifters 713 of RF chain 716, to provide a constructive and/or destructive interference, configured to change the beamforming scheme of antenna subarray 706 and to change the direction of a directional beam generated by antenna sub-array 706. Phases of the antenna elements 717 of antenna subarray 708 may be shifted, e.g., by phase shifters 713 of RF chain 718, to provide a constructive and/or destructive interference, configured to change the beamforming scheme of antenna subarray 708 and to change the direction of a directional beam generated by antenna sub-array 708.

In some demonstrative embodiments, phase shifters 713 may be discrete, e.g., configured to rotate the phase of the antenna elements of antenna subarrays 702, 704, 706 and 708 to a limited set of values, for example, 0, ±π/2, and it or any other values, allowing only a relatively coarse beamforming for changing a direction of directional beams formed by antenna subarrays 702, 704, 706 and 708.

In some demonstrative embodiments, RF chains 712, 714, 716 and/or 718 may include a summer/splitter block coupled to phase shifters 713. The summer/splitter block of an RF chain, e.g., RF chain 712, may include a splitter, e.g., a multiplexer, configured to reproduce and split an RF signal processed by the RF chain, e.g., RF signal 723, between the antenna elements 717 of an antenna subarray coupled to the RF chain, e.g., antenna sub-array 702, and to couple the reproduced signals of the RF signal, e.g., RF signal 723, to phase shifters 713, e.g., when transmitting RF signal 723 via a beam formed by antenna sub-array 702.

In some demonstrative embodiments, the summer/splitter block of the RF chain may include a summer configured to sum into the RF signal processed by the RF chain, e.g. RF signal 723, signals received from the antenna elements 717 of the antenna subarray coupled to the RF chain, e.g., when receiving RF signal 723 via the beam formed by antenna sub-array 702.

In some demonstrative embodiments, utilizing four RF chains 712, 714, 716 and 718 may enable baseband processing of up to four independent signals, e.g., carrying different data. For example, RF chains 712, 714, 716 and 718 may enable baseband processing, e.g., independent baseband processing, of RF signals 723, 725, 727 and 729 communicated via a composite directional beam, e.g., composite beam 157 (FIG. 1), formed by antenna subarrays 702, 704, 706 and 708.

In some demonstrative embodiments, wireless communication unit 700 may utilize RF chains 712, 714, 716 and 718 to perform beamformed diversity communication with the first and second users, for example, via first and second diversity beams 790 and 792, e.g., as described below.

In some demonstrative embodiments, baseband 703 may be configured to control antenna subarrays 702, 704, 706 and 708 to form two diversity beams for communicating a MU-MIMO wireless transmission with the first and second users.

In some demonstrative embodiments, baseband 703 may process data streams 761 and 763 into the MU-MIMO wireless transmission to be communicated utilizing a MU-MIMO beamformed scheme, e.g., as described below.

Some demonstrative embodiments are described herein with reference to a wireless communication unit, e.g., wireless communication unit 700, configured to perform both transmission and reception of a MIMO beamformed communication. Other embodiments may include a wireless communication unit capable of performing only one of transmission and reception of a MIMO beamformed communication.

In some demonstrative embodiments, wireless communication unit 700 may include a plurality of baseband (BB) to RF (BB2RF) converters, e.g., Digital-Analog converters (DACs), interfacing between baseband 703 and RF chains 712, 714, 716 and 718. For example, wireless communication unit 700 may include a DAC 722 interfacing between RF chain 712 and baseband 703, a DAC 724 interfacing between RF chain 714 and baseband 703, a DAC 726 interfacing between RF chain 716 and baseband 703, and a DAC 728 interfacing between RF chain 718 and baseband 703.

In some demonstrative embodiments, DAC 722 may convert RF signal 723 into a baseband data signal 733 and vice versa, DAC 724 may convert RF signal 725 into a baseband data signal 735 and vice versa, DAC 726 may convert RF signal 727 into a baseband data signal 737 and vice versa, and/or DAC 728 may convert RF signal 729 into a baseband data signal 739 and vice versa.

In one example, DAC 722 may convert RF signal 723 into baseband data signal 733, DAC 724 may convert RF signal 725 into baseband data signal 735, DAC 726 may convert RF signal 727 into baseband data signal 737, and/or DAC 728 may convert RF signal 729 into baseband data signal 739, e.g., if wireless communication unit 700 receives the MU-MIMO wireless transmission.

In one example, DAC 722 may convert baseband data signal 733 into RF signal 723, DAC 724 may convert baseband data signal 735 into RF signal 725, DAC 726 may convert baseband data signal 737 into RF signal 727, and/or DAC 728 may convert baseband data signal 739 into RF signal 729, e.g., if wireless communication unit 700 transmits the MU-MIMO wireless transmission.

In some demonstrative embodiments, DAC 722, 724, 726 and/or 728 may include down-converters, configured to convert an RF signal into a baseband data signal, and to provide the baseband data signal to baseband 703, e.g., if wireless communication unit 700 receives the MU-MIMO wireless transmission.

In some demonstrative embodiments, DAC 722, 724, 726 and/or 728 may include up-converters, configured to convert a baseband data signal into an RF signal and to provide the RF signal to an RF chain, e.g., if wireless communication unit 700 transmits the MU-MIMO wireless transmission.

In some demonstrative embodiments, wireless communication unit 700 may be configured to perform hybrid beamforming. The hybrid beamforming may include, for example, performing a coarse beamforming in RF chains 712, 714, 716 and 718, e.g., using phase-shifters 713; and fine beamforming in baseband 703, e.g., as described below.

In one example, the coarse beamforming may be performed, for example, as part of a beamforming procedure for setting up a beamformed link.

In some demonstrative embodiments, the fine beamforming may include diversity processing, e.g., MIMO processing, MISO processing and/or SIMO processing, at baseband 703. For example, the MIMO processing may include, for example, closed-loop (CL) MIMO processing, Open Loop (OL) MIMO processing, Space-Block Code (SBC) MIMO processing, e.g., Space Time Block Code (STBC) MIMO processing, Space Frequency Block Code (SFBC) MIMO processing, and the like.

In some demonstrative embodiments, baseband 703 may process data streams 761 and 763 according to an OFDM modulation scheme. For example, wireless communication unit 700 may include an Inverse-Fast-Fourier-Transform (IFFT) module 732 to convert baseband signal 733 between a frequency domain 705 and a time domain 707; an IFFT module 734 to convert baseband signal 735 between frequency domain 705 and time domain 707; an IFFT module 736 to convert baseband signal 737 between frequency domain 705 and time domain 707; and/or an IFFT module 738 to convert baseband signal 739 between frequency domain 705 and time domain 707. In one example, IFFT modules 732, 734, 736 and 738 may be included as part of BB processing chains 630 (FIG. 6).

In some demonstrative embodiments, baseband 703 may include a coding and modulation module 760 configured to encode and/or module data stream 761 according to an encoding and/or modulation scheme; and a coding and modulation module 762 configured to encode and/or module data stream 763 according to an encoding and/or modulation scheme. For example, modules 760 and 762 may perform the functionality of modules 662 (FIG. 6).

In some demonstrative embodiments, baseband 703 may include fine beamforming processing blocks to process the encoded streams according to a MIMO processing scheme. For example, baseband 703 may include a pair of fine beamforming blocks 742 to apply fine beamforming to signals to be communicated via antenna subarray 702, a pair of fine beamforming blocks 744 to apply fine beamforming to signals to be communicated via antenna subarray 704, a pair of fine beamforming blocks 746 to apply fine beamforming to signals to be communicated via antenna subarray 706, and a pair of fine beamforming blocks 748 to apply fine beamforming to signals to be communicated via antenna subarray 708. For example, fine beamforming blocks 742, 744, 746 and 748 may be included as part of MIMO encoder/decoder 640 (FIG. 6).

In some demonstrative embodiments, a beamforming block of blocks 742, 744, 746 and 748 corresponding to a coding block of blocks 760 and 762 may be configured to multiply the modulated data streams from the coding block by a weighting vector. For example, a first block of blocks 742 may multiply the modulated data streams from coding block 760 by a first weighting vector, and a second block of blocks 742 may multiply the modulated data streams from coding block 762 by a second weighting vector. The outputs of a pair of blocks, e.g., blocks 742, may be combined, e.g., by a summation circuit, into a single stream to be processed by an RF chain, e.g., RF chain 712, of a corresponding antenna sub-array. For example, a controller, e.g., controller 122 (FIG. 1) or controller 623 (FIG. 1) may control the weighting vectors applied by blocks 742, 744, 746 and 748.

In some demonstrative embodiments, the RF (coarse) beamforming performed by RF chains 712, 714, 716 and 718 combined with the BB (fine) beamforming performed by blocks 742, 744, 746 and 748 may be configured to result in the communicating of each of data streams 761 and 763 over a corresponding beam of beams 790 and 792.

In some demonstrative embodiments, using OFDM signals may allow for easy realization of various Orthogonal-Frequency-Division-Multiple-Access (OFDMA) schemes of frequency reuse, which may be used, for example, to manage interference within a wireless communication cell and/or between neighboring wireless communication cells, e.g., the small cells described above with reference to FIG. 1.

In one example, available OFDM subcarriers may be divided into a set of frequency sub-channels, which may include, for example, contiguous or non-contiguous subcarriers. Different frequency sub-channels may be assigned, for example, to different users or base stations, e.g., depending on the desired frequency reuse scheme.

In some demonstrative embodiments, the frequency reuse scheme may be utilized together with the RF beamforming in the vertical plane, e.g., as described above.

In one example, a BS, e.g., device 102 (FIG. 1), may steer an antenna array, e.g., antenna array 107 (FIG. 1), with the vertical BF, e.g., as described above with reference to FIG. 4B, to point onto cell-edge users, e.g., the most distant users from the BS. The vertical BF may steer the beam very close to the horizontal plane to reach the cell-edge users, while only a portion of the frequency sub-channels may be assigned to the cell-edge users. Accordingly, nearby cell-edge users associated with another cell may use another portion of the frequency sub-channels and, as a result, inter-cell interference may be avoided.

In some demonstrative embodiments, the baseband beamforming may be adapted, e.g., in OFDMA-based communication, on a per-subcarrier basis, for example, to improve the BF accuracy, support frequency division of users, e.g., frequency reuse between the users, and/or to compensate for some frequency selectivity of the wireless channel.

Some demonstrative embodiments are described above with reference to a wireless communication unit, e.g., wireless communication unit 700, configured to handle wireless communication signals transmitted via an antenna array. However, in other embodiments, the wireless communication unit may be configured to handle wireless communication signals received via the antenna array.

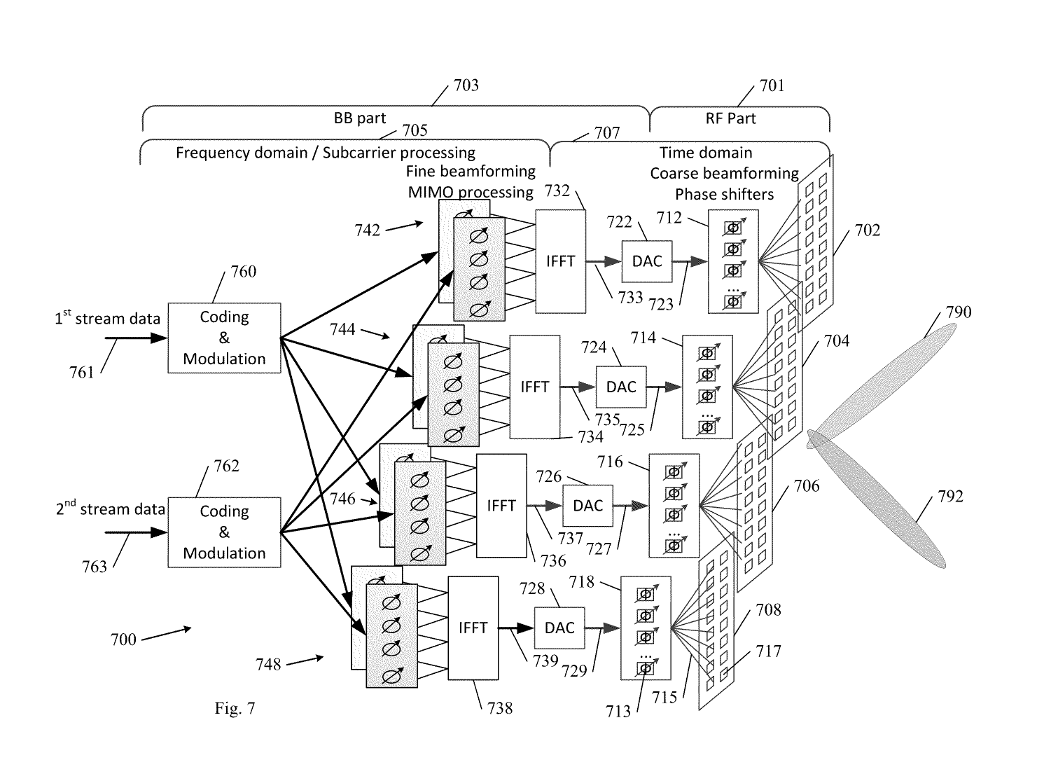

Reference is made to FIG. 8, which schematically illustrates a method of wireless communication via an antenna array, in accordance with some demonstrative embodiments. In some embodiments, one or more of the operations of the method of FIG. 8 may be performed by a wireless communication system, e.g., system 100 (FIG. 1); a wireless communication device, e.g., device 102 (FIG. 1) and/or device 104 (FIG. 1); a baseband, e.g., baseband 150 (FIG. 1); a controller, e.g., controller 122 (FIG. 1); a wireless communication unit, e.g., wireless communication units 110 and/or 120 (FIG. 1); and/or an antenna array, e.g., antenna array 107 (FIG. 1).

As indicated at block 802, the method may include generating a directional beam steerable along both a first axis and a second axis perpendicular to the first axis. For example, controller 122 (FIG. 1) may control antenna array 107 (FIG. 1) to communicate a beamformed communication via a directional beam steerable in both the horizontal and vertical directions, e.g., as described above.

As indicated at block 804, the method may include generating the directional beam having a first beam-width in a first plane including the first axis, and a second beam-width in a second plane including the second axis. The first beam-width may be narrower than the second beam-width. For example, antenna module 400 (FIG. 4A) may generate beam 404 (FIG. 4A) having a narrow beam-width in the vertical plane and a wide beam-width in the horizontal plane, e.g., as described above.

As indicated at block 806, the method may include steering the directional beam along the second axis. For example, controller 122 (FIG. 1) may control antenna array 107 (FIG. 1) to steer the directional beam along the horizontal axis, e.g., as described above.

As indicated at block 808, the method may include steering the directional beam along the first axis. For example, controller 122 (FIG. 1) may control antenna array 107 (FIG. 1) to steer the directional beam along the vertical axis, e.g., as described above.

As indicated at block 810, the method may include generating a plurality of directional beams for communicating a beamformed diversity wireless transmission over a plurality of beamformed links. For example, controller 122 (FIG. 1) may control antenna array 107 (FIG. 1) to generate a plurality of beams for communicating a MIMO transmission, e.g., a SU-MIMO or MU-MIMO transmission, e.g., as described above.

As indicated at block 812, the method may include communicating a beamformed communication via the directional beam. For example, controller 122 (FIG. 1) may control antenna array 107 (FIG. 1) to communicate a beamformed communication via a directional beam steerable in both the horizontal and vertical directions, e.g., as described above.

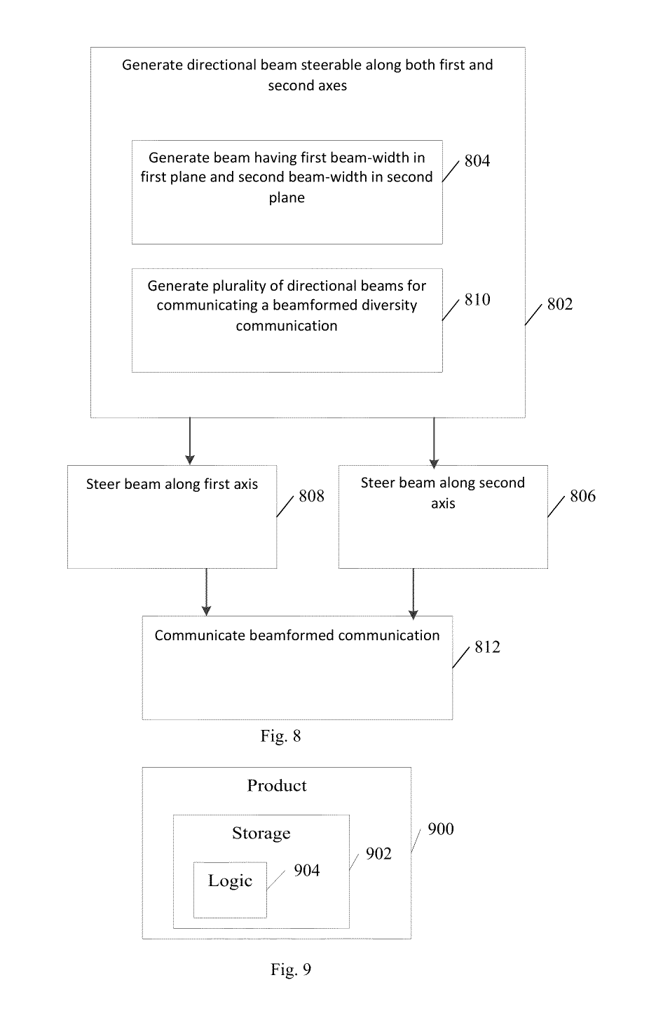

Reference is made to FIG. 9, which schematically illustrates a product of manufacture 900, in accordance with some demonstrative embodiments. Product 900 may include a non-transitory machine-readable storage medium 902 to store logic 904, which may be used, for example, to perform at least part of the functionality of device 102 (FIG. 1), device 104 (FIG. 1), wireless communication unit 110 (FIG. 1), wireless communication unit 120 (FIG. 1), baseband 150 (FIG. 1), BF processor 123 (FIG. 1), and/or controller 122 (FIG. 1) and/or to perform one or more operations of the method of FIG. 8. The phrase “non-transitory machine-readable medium” is directed to include all computer-readable media, with the sole exception being a transitory propagating signal.

In some demonstrative embodiments, product 900 and/or machine-readable storage medium 902 may include one or more types of computer-readable storage media capable of storing data, including volatile memory, non-volatile memory, removable or non-removable memory, erasable or non-erasable memory, writeable or re-writeable memory, and the like. For example, machine-readable storage medium 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus of wireless communication, the apparatus comprising an antenna array comprising a plurality of antenna modules arranged along a first axis, an antenna module of the antenna modules including an antenna sub-array coupled to a Radio-Frequency (RF) chain, the antenna sub-array including a plurality of antenna elements arranged along a second axis, the second axis is perpendicular to the first axis, and the RF chain is to process RF signals communicated via the plurality of antenna elements.

Example 2 includes the subject matter of Example 1 and optionally, wherein the antenna array is configured to perform the functionality of a modular antenna array including a plurality of modular antenna elements, wherein each antenna sub-array of the plurality of antenna modules is to perform the functionality of a modular antenna element of the plurality of modular antenna elements.

Example 3 includes the subject matter of Example 1 or 2 and optionally, wherein the plurality of antenna elements of the antenna module are configured to generate a directional beam having a first beam-width in a first plane including the first axis and perpendicular to the second axis, and a second beam-width in a second plane including the second axis and perpendicular to the first axis, the first beam-width is wider than the second beam-width.

Example 4 includes the subject matter of any one of Examples 1-3 and optionally, wherein the antenna array is to steer one or more directional beams along the second axis.

Example 5 includes the subject matter of any one of Examples 1-4 and optionally, wherein the antenna array is to steer one or more directional beams along the first axis.

Example 6 includes the subject matter of any one of Examples 1-5 and optionally, wherein the antenna array is to generate one or more directional composite beams formed by a combination of antenna elements of the plurality of antenna modules, and to steer the directional composite beams for communicating a beamformed diversity wireless transmission over a plurality of beamformed links.

Example 7 includes the subject matter of Example 6 and optionally, wherein the beamformed diversity wireless transmission comprises a Multi-Input-Multi-Output (MIMO) transmission.

Example 8 includes the subject matter of Example 7 and optionally, wherein the beamformed diversity wireless transmission comprises a Single-User (SU) MIMO transmission.

Example 9 includes the subject matter of Example 7 and optionally, wherein the beamformed diversity wireless transmission comprises a Multi-User (MU) MIMO transmission.

Example 10 includes the subject matter of any one of Examples 6-9 and optionally, wherein RF chains of the plurality of antenna modules are to steer the composite beams along the second axis.

Example 11 includes the subject matter of any one of Examples 6-10 and optionally, wherein the antenna array is to steer the composite directional beams between a plurality of sector coverage areas.

Example 12 includes the subject matter of Example 11 and optionally, wherein the plurality of sectors comprises sectors along the second axis.

Example 13 includes the subject matter of Example 11 or 12 and optionally, wherein the plurality of sectors comprises sectors along the first axis.

Example 14 includes the subject matter of any one of Examples 11-13 and optionally, wherein the antenna array is to steer the composite directional beams to an area covering a plurality of users.

Example 15 includes the subject matter of any one of Examples 6-14 and optionally, comprising a beamforming processor to process the beamformed diversity wireless transmission.

Example 16 includes the subject matter of any one of Examples 1-15 and optionally, wherein the plurality of antenna modules comprises at least one row of antenna modules, and wherein the antenna sub-array includes at least one column of antenna elements.

Example 17 includes the subject matter of any one of Examples 1-16 and optionally, wherein the plurality of antenna elements includes two or more sets of antenna elements arranged along two or more parallel lines in parallel to the second axis.

Example 18 includes the subject matter of any one of Examples 1-17 and optionally, wherein the plurality of antenna modules includes two or more sets of antenna modules arranged along two or more parallel lines, in parallel to the first axis.

Example 19 includes the subject matter of Example 18 and optionally, wherein the antenna array is to generate a steerable composite beam formed by at least two beams, the two or more beams generated by two or more antenna modules on a line parallel to the second axis.

Example 20 includes the subject matter of any one of Examples 1-19 and optionally, wherein the antenna array is to communicate over a millimeter-wave (mmWave) frequency band.

Example 21 includes a system of wireless communication, the system comprising a wireless communication device including an antenna array comprising a plurality of antenna modules arranged along a first axis, an antenna module of the antenna modules including an antenna sub-array coupled to a Radio-Frequency (RF) chain, the antenna sub-array including a plurality of antenna elements arranged along a second axis, the second axis is perpendicular to the first axis, and the RF chain is to process RF signals communicated via the plurality of antenna elements; and a processor to control the antenna array to communicate a beamformed communication via one or more directional beams steerable along both the first and second axes.

Example 22 includes the subject matter of Example 21 and optionally, wherein the antenna array is configured to perform the functionality of a modular antenna array including a plurality of modular antenna elements, wherein each antenna sub-array of the plurality of antenna modules is to perform the functionality of a modular antenna element of the plurality of modular antenna elements.

Example 23 includes the subject matter of Example 21 or 22 and optionally, wherein the plurality of antenna elements of the antenna module are configured to generate a directional beam having a first beam-width in a first plane including the first axis and perpendicular to the second axis, and a second beam-width in a second plane including the second axis and perpendicular to the first axis, the first beam-width is wider than the second beam-width.

Example 24 includes the subject matter of any one of Examples 21-23 and optionally, wherein the antenna array is to steer the one or more directional beams along the second axis.

Example 25 includes the subject matter of any one of Examples 21-24 and optionally, wherein the antenna array is to steer the one or more directional beams along the first axis.

Example 26 includes the subject matter of any one of Examples 21-25 and optionally, wherein the antenna array is to generate one or more directional composite beams formed by a combination of antenna elements of the plurality of antenna modules, and to steer the directional composite beams for communicating a beamformed diversity wireless transmission over a plurality of beamformed links.

Example 27 includes the subject matter of Example 26 and optionally, wherein the beamformed diversity wireless transmission comprises a Multi-Input-Multi-Output (MIMO) transmission.

Example 28 includes the subject matter of Example 27 and optionally, wherein the beamformed diversity wireless transmission comprises a Single-User (SU) MIMO transmission.

Example 29 includes the subject matter of Example 27 and optionally, wherein the beamformed diversity wireless transmission comprises a Multi-User (MU) MIMO transmission.

Example 30 includes the subject matter of any one of Examples 26-29 and optionally, wherein RF chains of the plurality of antenna modules are to steer the composite beams along the second axis.

Example 31 includes the subject matter of any one of Examples 26-30 and optionally, wherein the antenna array is to steer the composite directional beams between a plurality of sector coverage areas.

Example 32 includes the subject matter of Example 31 and optionally, wherein the plurality of sectors comprises sectors along the second axis.

Example 33 includes the subject matter of Example 31 or 32 and optionally, wherein the plurality of sectors comprises sectors along the first axis.

Example 34 includes the subject matter of any one of Examples 31-33 and optionally, wherein the antenna array is to steer the composite directional beams to an area covering a plurality of users.

Example 35 includes the subject matter of any one of Examples 26-34 and optionally, comprising a baseband to process the beamformed diversity wireless transmission.

Example 36 includes the subject matter of any one of Examples 21-35 and optionally, wherein the plurality of antenna modules comprises at least one row of antenna modules, and wherein the antenna sub-array includes at least one column of antenna elements.

Example 37 includes the subject matter of any one of Examples 21-36 and optionally, wherein the plurality of antenna elements includes two or more sets of antenna elements arranged along two or more parallel lines in parallel to the second axis.

Example 38 includes the subject matter of any one of Examples 21-37 and optionally, wherein the plurality of antenna modules includes two or more sets of antenna modules arranged along two or more parallel lines, in parallel to the first axis.

Example 39 includes the subject matter of Example 38 and optionally, wherein the antenna array is to generate a steerable composite beam formed by at least two beams, the two or more beams generated by two or more antenna modules on a line parallel to the second axis.

Example 40 includes the subject matter of any one of Examples 21-39 and optionally, wherein the antenna array is to communicate over a millimeter-wave (mmWave) frequency band.

Example 41 includes a method of wireless communication, the method comprising controlling an antenna array to generate one or more directional beams steerable along both a first axis and a second axis, the second axis perpendicular to the first axis, wherein the antenna array comprises a plurality of antenna modules arranged along the first axis, an antenna module of the antenna modules including an antenna sub-array coupled to a Radio-Frequency (RF) chain, the antenna sub-array including a plurality of antenna elements arranged along the second axis, and the RF chain is to process RF signals communicated via the plurality of antenna elements.

Example 42 includes the subject matter of Example 41 and optionally, comprising controlling the antenna array to perform the functionality of a modular antenna array including a plurality of modular antenna elements, wherein each antenna sub-array of the plurality of antenna modules is to perform the functionality of a modular antenna element of the plurality of modular antenna elements.

Example 43 includes the subject matter of Example 41 or 42 and optionally, comprising controlling the plurality of antenna elements of the antenna module to generate a directional beam having a first beam-width in a first plane including the first axis and perpendicular to the second axis, and a second beam-width in a second plane including the second axis and perpendicular to the first axis, the first beam-width is wider than the second beam-width.

Example 44 includes the subject matter of any one of Examples 41-43 and optionally, comprising steering one or more directional beams along the second axis.

Example 45 includes the subject matter of any one of Examples 41-44 and optionally, comprising steering one or more directional beams along the first axis.

Example 46 includes the subject matter of any one of Examples 41-45 and optionally, comprising generating one or more directional composite beams formed by a combination of antenna elements of the plurality of antenna modules, and steering the directional composite beams for communicating a beamformed diversity wireless transmission over a plurality of beamformed links.

Example 47 includes the subject matter of Example 46 and optionally, wherein the beamformed diversity wireless transmission comprises a Multi-Input-Multi-Output (MIMO) transmission.

Example 48 includes the subject matter of Example 47 and optionally, wherein the beamformed diversity wireless transmission comprises a Single-User (SU) MIMO transmission.

Example 49 includes the subject matter of Example 47 and optionally, wherein the beamformed diversity wireless transmission comprises a Multi-User (MU) MIMO transmission.

Example 50 includes the subject matter of any one of Examples 46-49 and optionally, comprising controlling RF chains of the plurality of antenna modules to steer the composite beams along the second axis.

Example 51 includes the subject matter of any one of Examples 46-50 and optionally, comprising steering the composite directional beams between a plurality of sector coverage areas.

Example 52 includes the subject matter of Example 51 and optionally, wherein the plurality of sectors comprises sectors along the second axis.

Example 53 includes the subject matter of Example 51 or 52 and optionally, wherein the plurality of sectors comprises sectors along the first axis.

Example 54 includes the subject matter of any one of Examples 51-53 and optionally, comprising steering the composite directional beams to an area covering a plurality of users.

Example 55 includes the subject matter of any one of Examples 46-54 and optionally, comprising processing the beamformed diversity wireless transmission by a central beamforming processor.

Example 56 includes the subject matter of any one of Examples 41-55 and optionally, wherein the plurality of antenna modules comprises at least one row of antenna modules, and wherein the antenna sub-array includes at least one column of antenna elements.

Example 57 includes the subject matter of any one of Examples 41-56 and optionally, wherein the plurality of antenna elements includes two or more sets of antenna elements arranged along two or more parallel lines in parallel to the second axis.

Example 58 includes the subject matter of any one of Examples 41-57 and optionally, wherein the plurality of antenna modules includes two or more sets of antenna modules arranged along two or more parallel lines, in parallel to the first axis.

Example 59 includes the subject matter of Example 58 and optionally, comprising generating a steerable composite beam formed by at least two beams, the two or more beams generated by two or more antenna modules on a line parallel to the second axis.

Example 60 includes the subject matter of any one of Examples 41-59 and optionally, comprising communicating over a millimeter-wave (mmWave) frequency band.

Example 61 includes a product including a non-transitory storage medium having stored thereon instructions that, when executed by a machine, result in controlling an antenna array to generate one or more directional beams steerable along both a first axis and a second axis, the second axis perpendicular to the first axis, wherein the antenna array comprises a plurality of antenna modules arranged along the first axis, an antenna module of the antenna modules including an antenna sub-array coupled to a Radio-Frequency (RF) chain, the antenna sub-array including a plurality of antenna elements arranged along the second axis, and the RF chain is to process RF signals communicated via the plurality of antenna elements.

Example 62 includes the subject matter of Example 61 and optionally, wherein the instructions result in controlling the antenna array to perform the functionality of a modular antenna array including a plurality of modular antenna elements, wherein each antenna sub-array of the plurality of antenna modules is to perform the functionality of a modular antenna element of the plurality of modular antenna elements.

Example 63 includes the subject matter of Example 61 or 62 and optionally, wherein the instructions result in controlling the plurality of antenna elements of the antenna module to generate a directional beam having a first beam-width in a first plane including the first axis and perpendicular to the second axis, and a second beam-width in a second plane including the second axis and perpendicular to the first axis, the first beam-width is wider than the second beam-width.

Example 64 includes the subject matter of any one of Examples 61-63 and optionally, wherein the instructions result in steering one or more directional beams along the second axis.

Example 65 includes the subject matter of any one of Examples 61-64 and optionally, wherein the instructions result in steering one or more directional beams along the first axis.

Example 66 includes the subject matter of any one of Examples 61-65 and optionally, wherein the instructions result in generating one or more directional composite beams formed by a combination of antenna elements of the plurality of antenna modules, and steering the directional composite beams for communicating a beamformed diversity wireless transmission over a plurality of beamformed links.

Example 67 includes the subject matter of Example 66 and optionally, wherein the beamformed diversity wireless transmission comprises a Multi-Input-Multi-Output (MIMO) transmission.

Example 68 includes the subject matter of Example 67 and optionally, wherein the beamformed diversity wireless transmission comprises a Single-User (SU) MIMO transmission.

Example 69 includes the subject matter of Example 67 and optionally, wherein the beamformed diversity wireless transmission comprises a Multi-User (MU) MIMO transmission.

Example 70 includes the subject matter of any one of Examples 66-69 and optionally, wherein the instructions result in controlling RF chains of the plurality of antenna modules to steer the composite beams along the second axis.

Example 71 includes the subject matter of any one of Examples 66-70 and optionally, wherein the instructions result in steering the composite directional beams between a plurality of sector coverage areas.

Example 72 includes the subject matter of Example 71 and optionally, wherein the plurality of sectors comprises sectors along the second axis.

Example 73 includes the subject matter of Example 71 or 72 and optionally, wherein the plurality of sectors comprises sectors along the first axis.

Example 74 includes the subject matter of any one of Examples 71-73 and optionally, wherein the instructions result in steering the composite directional beams to an area covering a plurality of users.

Example 75 includes the subject matter of any one of Examples 66-74 and optionally, wherein the instructions result in processing the beamformed diversity wireless transmission by a central beamforming processor.

Example 76 includes the subject matter of any one of Examples 61-75 and optionally, wherein the plurality of antenna modules comprises at least one row of antenna modules, and wherein the antenna sub-array includes at least one column of antenna elements.

Example 77 includes the subject matter of any one of Examples 61-76 and optionally, wherein the plurality of antenna elements includes two or more sets of antenna elements arranged along two or more parallel lines in parallel to the second axis.

Example 78 includes the subject matter of any one of Examples 61-77 and optionally, wherein the plurality of antenna modules includes two or more sets of antenna modules arranged along two or more parallel lines, in parallel to the first axis.

Example 79 includes the subject matter of Example 78 and optionally, wherein the instructions result in generating a steerable composite beam formed by at least two beams, the two or more beams generated by two or more antenna modules on a line parallel to the second axis.

Example 80 includes the subject matter of any one of Examples 61-79 and optionally, wherein the instructions result in communicating over a millimeter-wave (mmWave) frequency band.

Example 81 includes an apparatus of wireless communication, the apparatus comprising means for controlling an antenna array to generate one or more directional beams steerable along both a first axis and a second axis, the second axis perpendicular to the first axis, wherein the antenna array comprises a plurality of antenna modules arranged along the first axis, an antenna module of the antenna modules including an antenna sub-array coupled to a Radio-Frequency (RF) chain, the antenna sub-array including a plurality of antenna elements arranged along the second axis, and the RF chain is to process RF signals communicated via the plurality of antenna elements.

Example 82 includes the subject matter of Example 81 and optionally, comprising means for controlling the antenna array to perform the functionality of a modular antenna array including a plurality of modular antenna elements, wherein each antenna sub-array of the plurality of antenna modules is to perform the functionality of a modular antenna element of the plurality of modular antenna elements.

Example 83 includes the subject matter of Example 81 or 82 and optionally, comprising means for controlling the plurality of antenna elements of the antenna module to generate a directional beam having a first beam-width in a first plane including the first axis and perpendicular to the second axis, and a second beam-width in a second plane including the second axis and perpendicular to the first axis, the first beam-width is wider than the second beam-width.

Example 84 includes the subject matter of any one of Examples 81-83 and optionally, comprising means for steering one or more directional beams along the second axis.

Example 85 includes the subject matter of any one of Examples 81-84 and optionally, comprising means for steering one or more directional beams along the first axis.

Example 86 includes the subject matter of any one of Examples 81-85 and optionally, comprising means for generating one or more directional composite beams formed by a combination of antenna elements of the plurality of antenna modules, and steering the directional composite beams for communicating a beamformed diversity wireless transmission over a plurality of beamformed links.

Example 87 includes the subject matter of Example 86 and optionally, wherein the beamformed diversity wireless transmission comprises a Multi-Input-Multi-Output (MIMO) transmission.

Example 88 includes the subject matter of Example 87 and optionally, wherein the beamformed diversity wireless transmission comprises a Single-User (SU) MIMO transmission.

Example 89 includes the subject matter of Example 87 and optionally, wherein the beamformed diversity wireless transmission comprises a Multi-User (MU) MIMO transmission.

Example 90 includes the subject matter of any one of Examples 86-89 and optionally, comprising means for controlling RF chains of the plurality of antenna modules to steer the composite beams along the second axis.

Example 91 includes the subject matter of any one of Examples 86-90 and optionally, comprising means for steering the composite directional beams between a plurality of sector coverage areas.

Example 92 includes the subject matter of Example 91 and optionally, wherein the plurality of sectors comprises sectors along the second axis.

Example 93 includes the subject matter of Example 91 or 92 and optionally, wherein the plurality of sectors comprises sectors along the first axis.

Example 94 includes the subject matter of any one of Examples 91-93 and optionally, comprising means for steering the composite directional beams to an area covering a plurality of users.

Example 95 includes the subject matter of any one of Examples 86-94 and optionally, comprising means for processing the beamformed diversity wireless transmission by a central beamforming processor.

Example 96 includes the subject matter of any one of Examples 81-95 and optionally, wherein the plurality of antenna modules comprises at least one row of antenna modules, and wherein the antenna sub-array includes at least one column of antenna elements.

Example 97 includes the subject matter of any one of Examples 81-96 and optionally, wherein the plurality of antenna elements includes two or more sets of antenna elements arranged along two or more parallel lines in parallel to the second axis.

Example 98 includes the subject matter of any one of Examples 81-97 and optionally, wherein the plurality of antenna modules includes two or more sets of antenna modules arranged along two or more parallel lines, in parallel to the first axis.

Example 99 includes the subject matter of Example 98 and optionally, comprising means for generating a steerable composite beam formed by at least two beams, the two or more beams generated by two or more antenna modules on a line parallel to the second axis.

Example 100 includes the subject matter of any one of Examples 81-99 and optionally, comprising means for communicating over a millimeter-wave (mmWave) frequency band.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
an antenna array comprising a plurality of antenna modules arranged along a first axis, an antenna module of said antenna modules including an antenna sub-array coupled to a Radio-Frequency (RF) chain, said antenna sub-array including a plurality of antenna elements arranged along a second axis, said second axis is perpendicular to said first axis, and said RF chain is to process RF signals communicated via said plurality of antenna elements.

2. The apparatus of claim 1, wherein said antenna array is configured to perform the functionality of a modular antenna array including a plurality of modular antenna elements, wherein each antenna sub-array of said plurality of antenna modules is to perform the functionality of a modular antenna element of said plurality of modular antenna elements.

3. The apparatus of claim 1, wherein the plurality of antenna elements of said antenna module are configured to generate a directional beam having a first beam-width in a first plane including said first axis and perpendicular to said second axis, and a second beam-width in a second plane including said second axis and perpendicular to said first axis, said first beam-width is wider than said second beam-width.

4. The apparatus of claim 1, wherein said antenna array is to steer one or more directional beams along said second axis.

5. The apparatus of claim 1, wherein said antenna array is to steer one or more directional beams along said first axis.

6. The apparatus of claim 1, wherein said antenna array is to generate one or more directional composite beams formed by a combination of antenna elements of said plurality of antenna modules, and to steer said directional composite beams for communicating a beamformed diversity wireless transmission over a plurality of beamformed links.

7. The apparatus of claim 6, wherein said beamformed diversity wireless transmission comprises a Multi-Input-Multi-Output (MIMO) transmission.

8. The apparatus of claim 7, wherein said beamformed diversity wireless transmission comprises a Single-User (SU) MIMO transmission.

9. The apparatus of claim 7, wherein said beamformed diversity wireless transmission comprises a Multi-User (MU) MIMO transmission.

10. The apparatus of claim 6, wherein said antenna array is to steer said composite directional beams between a plurality of sector coverage areas.

11. The apparatus of claim 10, wherein said antenna array is to steer said composite directional beams to an area covering a plurality of users.

12. The apparatus of claim 6 comprising a beamforming processor to process said beamformed diversity wireless transmission.

13. The apparatus of claim 1, wherein said plurality of antenna modules comprises at least one row of antenna modules, and wherein said antenna sub-array includes at least one column of antenna elements.

14. The apparatus of claim 1, wherein said plurality of antenna elements includes two or more sets of antenna elements arranged along two or more parallel lines in parallel to said second axis.

15. The apparatus of claim 1, wherein said plurality of antenna modules includes two or more sets of antenna modules arranged along two or more parallel lines, in parallel to said first axis.

16. The apparatus of claim 1, wherein said antenna array is to communicate over a millimeter-wave (mmWave) frequency band.

17. A system comprising:
a wireless communication device including:
an antenna array comprising a plurality of antenna modules arranged along a first axis, an antenna module of said antenna modules including an antenna sub-array coupled to a Radio-Frequency (RF) chain, said antenna sub-array including a plurality of antenna elements arranged along a second axis, said second axis is perpendicular to said first axis, and said RF chain is to process RF signals communicated via said plurality of antenna elements; and
a processor to control said antenna array to communicate a beamformed communication via one or more directional beams steerable along both said first and second axes.

18. The system of claim 17, wherein said antenna array is configured to perform the functionality of a modular antenna array including a plurality of modular antenna elements, wherein each antenna sub-array of said plurality of antenna modules is to perform the functionality of a modular antenna element of said plurality of modular antenna elements.

19. The system of claim 17, wherein said antenna array is to generate one or more directional composite beams formed by a combination of antenna elements of said plurality of antenna modules, and to steer said directional composite beams for communicating a beamformed diversity wireless transmission over a plurality of beamformed links.

20. The system of claim 19, wherein said beamformed diversity wireless transmission comprises a Multi-Input-Multi-Output (MIMO) transmission.

21. The system of claim 19, wherein said antenna array is to steer said composite directional beams between a plurality of sector coverage areas.

22. A method comprising:
controlling an antenna array to generate one or more directional beams steerable along both a first axis and a second axis, said second axis perpendicular to said first axis,
wherein said antenna array comprises a plurality of antenna modules arranged along said first axis, an antenna module of said antenna modules including an antenna sub-array coupled to a Radio-Frequency (RF) chain, said antenna sub-array including a plurality of antenna elements arranged along said second axis, and said RF chain is to process RF signals communicated via said plurality of antenna elements.

23. The method of claim 22 comprising controlling said antenna array to perform the functionality of a modular antenna array including a plurality of modular antenna elements, wherein each antenna sub-array of said plurality of antenna modules is to perform the functionality of a modular antenna element of said plurality of modular antenna elements.

24. The method of claim 22 comprising generating one or more directional composite beams formed by a combination of antenna elements of said plurality of antenna modules, and steering said directional composite beams for communicating a beamformed diversity wireless transmission over a plurality of beamformed links.

25. A product including a non-transitory storage medium having stored thereon instructions that, when executed by a machine, result in:
controlling an antenna array to generate one or more directional beams steerable along both a first axis and a second axis, said second axis perpendicular to said first axis,
wherein said antenna array comprises a plurality of antenna modules arranged along said first axis, an antenna module of said antenna modules including an antenna sub-array coupled to a Radio-Frequency (RF) chain, said antenna sub-array including a plurality of antenna elements arranged along said second axis, and said RF chain is to process RF signals communicated via said plurality of antenna elements.

26. The product of claim 25, wherein the instructions result in controlling said antenna array to perform the functionality of a modular antenna array including a plurality of modular antenna elements, wherein each antenna sub-array of said plurality of antenna modules is to perform the functionality of a modular antenna element of said plurality of modular antenna elements.

27. The product of claim 25, wherein the instructions result in controlling the plurality of antenna elements of said antenna module to generate a directional beam having a first beam-width in a first plane including said first axis and perpendicular to said second axis, and a second beam-width in a second plane including said second axis and perpendicular to said first axis, said first beam-width is wider than said second beam-width.

28. The product of claim 25, wherein the instructions result in generating one or more directional composite beams formed by a combination of antenna elements of said plurality of antenna modules, and steering said directional composite beams for communicating a beamformed diversity wireless transmission over a plurality of beamformed links.

29. The product of claim 28, wherein said beamformed diversity wireless transmission comprises a Multi-Input-Multi-Output (MIMO) transmission.

30. The product of claim 29, wherein said beamformed diversity wireless transmission comprises a Multi-User (MU) MIMO transmission.
